(19) United States
(12) Patent Application Publication
(10) Pub. No.: US 2016/0343100 A1
(43) Pub. Date: Nov. 24, 2016

(54) SYSTEMS AND METHODS FOR TRACKING AND VISUALIZING ACTIVITY OF COMPANIES AND STATE OWNED ENTERPRISES

(71) Applicant: RWR ADVISORY GROUP, LLC, Washington, DC, MD (US)

(72) Inventors: Andrew Davenport, Alexandria, VA (US); Roger W. Robinson, JR., Arlington, VA (US)

(21) Appl. No.: 15/158,320

(22) Filed: May 18, 2016

Related U.S. Application Data
(60) Provisional application No. 62/163,569, filed on May 19, 2015.

(51) Int. Cl. G06Q 50/26; G06Q 30/00; G06Q 10/06

(52) U.S. Cl. CPC G06Q 50/265; G06Q 10/0635; G06Q 10/063114; G06Q 30/0185

(57) ABSTRACT

Systems and methods for visualizing and analyzing company activity are provided. Specifically, a method may comprise receiving a user search input for one or more companies, receiving transaction information data associated with a list of one or more transactions involving the one or more companies, receiving location data describing the locations of the one or more transactions, receiving company information data about each identified transaction in the list of the one or more transactions, and identifying affiliate companies associated with the one or more companies involved in each identified transaction. The method may further comprise populating a geographic map with markers, where the markers correspond to the location of each identified transaction in the list of one or more transactions, and where the markers are generated based on the location-based transaction information. The populated map may then be displayed to a user on a user device.

### CROSS-REFERENCE TO RELATED APPLICATIONS

The present application claims priority to U.S. Provisional Patent Application No. 62/163,569, filed on May 19, 2015, the entire contents of which are hereby incorporated by reference for all purposes.

### BACKGROUND/SUMMARY

In the modern world, a large amount of data is collected on transactions involving companies, including state owned enterprises (SOEs). Currently however, this transactional data is rarely, if ever, analyzed and synthesized in a way that exposes the behavioral tendencies and thereby the motivations of these companies and SOEs. Thus, there is presently a lack of situational awareness concerning the global footprint of certain companies. Especially little is known about how much certain companies' business actions are influenced by non-commercial or strategic interests. In a hyper-connected global economy, this lack of transparency creates risk and uncertainty for parties in both the private and public sector.

For the private sector, enhanced situational awareness regarding the global footprint of certain companies, including SOEs, is relevant, due to these entities being competitors as well as potential partners and customers. Data and knowledge concerning their patterns of activity is valuable for corporate planning, due diligence, and risk management. Thus, companies can more appropriately devise their own strategies and plans according to an understanding of their competitors' (or partners' or customers′) activity.

Additionally, certain companies and/or SOEs may represent a significant threat to the safety/security of individuals, other companies and even nation states due to their involvement in illegal activities, engagement in dangerous business practices, corrupt ideologies and intentions as well as their being used, in a broader sense, as strategic arms of their respective home countries or governments. For example, some SOEs and companies may be involved in technology theft, cybersecurity hacks, human and labor rights abuses, government and political manipulation, imported labor, the distortion and manipulation of markets, soft power projection tools and as diplomatic or military assets used to compromise the foreign countries and governments where they do business. As such, these SOEs and/or companies may take actions that are damaging to other individuals, businesses or the foreign and domestic policy positions of national governments.

As such, it may be beneficial for the security of both the public and private sectors to more accurately anticipate the future actions of companies and SOEs. Being able to predict how a company or SOE will act is therefore important to safeguard against nefarious activity and more effectively develop strategies for prolonged individual and institutional stability. In order to anticipate how a company or SOE will act in the future, it is important to understand what they have been doing, and why. Said another way, recognizing the motivations driving a company or SOE's behavior may enable more accurate predictions of their activity in the future. Often, it is easier to discern the motivations behind a company's actions when equipped with a comprehensive understanding of their activity history. Hence, in order to better anticipate future company and SOE behavior, it may be crucial to have a thorough record of what it is they have been doing. One way to do so is by gathering and analyzing the transaction history of a company or SOE. Transactions involving companies and SOEs are reported to the public, and therefore represent datasets which can be used to quantify and evaluate company behavior. Thus, by analyzing the transactions a company or SOE is involved in, their agendas, motivations, and special interests may be elucidated.

However, understanding a single company or SOE's behavior based on their transactions is usually more complicated because the interests of other companies, SOEs, and even government entities can be involved. For example, companies and/or state owned enterprises (SOEs) may cooperate with one another by entering into one or more partnerships, mergers, acquisitions, etc. Further, these networks may be chiefly controlled by a single company or in some cases a group of companies. A company's actions therefore, may be motivated either in part or whole by other companies in their network and not strictly by their own economic development and profit expansion. For example, many SOEs may have government political agendas in mind when making decisions about future projects and strategies, due to their primary shareholder, in fact, being the national government. In other examples, a company that is a subsidiary of another parent company may act in ways that conform to the ideologies and/or desires of the parent company.

It may be difficult therefore, to sort out the underlying motivations and ultimate goals for many companies and SOEs without first understanding the networks and associations between them. Thus, more often than not, a company or SOE's activity record includes not only that specific company's activity record, but also the activity record of all companies and/or SOEs associated with it. An account of all transactional activity for a given company or SOE is not complete without also considering and identifying the transactional activity for all companies and/or SOEs associated with that company. Effectively, by identifying all the companies and SOEs associated with one another in a network, the collective activity, intentions, and behavior of the network, and therefore individual companies themselves can be better understood and anticipated.

However, identifying these networks can be very difficult, since the associations between companies are not always clear, nor publicly disclosed. The legally binding and publicized types of collaboration such as partnerships, mergers, acquisitions, etc., are subject to observation and scrutiny from competitors and the public. In an effort to reduce the amount of attention drawn to them, and, in some cases, conceal their activity, companies and/or state owned enterprises may organize themselves into networks that are not legally binding. Companies in these networks, while affiliated with one another, may not be publicly recognized as partners or subsidiaries of one another. As such, many companies and state owned enterprises that may appear to be independently owned and operated may in fact be players in vaster and more complicated corporate and government networks.

Thus, anticipating company and SOE behavior may be problematic for two reasons. Firstly, it may be difficult to organize the transactions of a company or SOE in a way that effectively elucidates the motivations of that company or SOE, since the motivations of a company or SOE are often complex and encompass the interests of many outside forces. Secondly, it is challenging to identify the associations between companies and/or SOEs in a network, since these collaborations may not be publicly recognized.

The inventors herein have recognized the issues described above and have devised systems and methods for addressing the issues. In particular, systems and methods for a transparent corporate activity tracker and user interface are provided. More specifically, the methods and systems described herein provide an approach for integrating crucial and relevant information about transactions such as their cost, parties involved, location, time, etc., and then compiling that information into one integrative display. Further, company and/or SOE activity may be overlaid on a geographic map so that the motivations and intentions of the company and/or SOE may be more transparent.

The present invention provides, among other advantages, methods and systems for helping a user track and predict company and SOE activity. In one embodiment, a method comprises receiving activity information regarding an activity involving one or more companies from one or more first storage devices, wherein the activity information includes one or more of a name, type, industry, date, monetary value, and location of the activity, and companies involved with the activity, identifying the companies involved with the activity based on the activity information, receiving company information regarding the companies involved with the activity from one or more second storage devices, the company information including an activity record of the companies involved with the activity, estimating a first risk level for the activity based on the company information, estimating a second risk level for the activity based on the activity information, determining a risk factor for the transaction based on the first risk level for each of the companies involved with the activity and the second risk level for the activity, generating an alert when the risk factor is greater than a threshold, and displaying the alert to a user on a display screen.

By estimating a risk level for a company based on the transaction and/or activity history of the company, an amount of processing power required to calculate the risk factor for a new activity and/or transaction involving the company may be reduced. Thus, the speed and efficiency of calculating a risk factor for a new transaction may be increased by estimating and storing a risk level for the companies involved in the transaction prior to receiving the information relating to a transaction. Thus, because the risk level for a company may be estimated based on company information, when calculating the risk factor for a given transaction, which may be based both on the risk levels for the companies involved in the transaction and the user preferences, processing power and an amount of time required to perform the calculation of the risk factor may be reduced relative to approaches where the risk level of the company and the risk factor are calculated concurrently. Thus, hardware and electrical components of one or more processors may be reduced.

In another representation, a method comprises: receiving a user search input for one or more companies; receiving transaction information data associated with a list of one or more transactions involving the one or more companies; receiving location data describing the locations of the one or more transactions; and receiving company information data for each identified transaction in the list of the one or more transactions. The received transaction information data may include one or more of the companies involved in the transaction, monetary values, industries, time periods, transaction status, persons involved for each identified transaction; type of transaction; whether the transaction is occurring in countries matching certain risk designations; whether the transaction involves companies matching certain risk designations; and whether the transaction involves persons matching certain risk designations. The method may further include identifying affiliate companies associated with the one or more companies involved in each identified transaction. The method may further include analyzing, with a server computer, the location data and transaction information data and generating location-based transaction information. Using the location-based transaction information, the method further includes populating a geographic map with markers, where the markers correspond to the location of each identified transaction in the list of one or more transactions, and where the markers are generated based on the location-based transaction information, where the transactions may be differentiated based on user defined parameters, where each parameter is matched to a different visual marker. The method may further include transmitting the populated geographic map to the user device and displaying the populated geographic map on the user device.

In another representation, a method may comprise receiving user preferences corresponding to one or more companies of interest from a user via a user device, and storing said user preferences in a user profile, the user profile stored on a first storage device of a first remote server. Further, the method may additionally include receiving transaction information data regarding a transaction from one or more second storage devices, wherein the transaction information data may include a plurality of data points, where the data points may correspond to and/or represent one or more of the name, type, industry, and location of the transactions, and companies involved with the transaction. Similarly the company information data may comprise a plurality of data points where the data points may correspond to and/or represent company activity records for one or more companies involved in the transaction, transaction history of the one or more companies, employee lists, names of executives, contracts involving the one or more companies, involvement in cyber-crime and/or other illegal activities, and any other published information about the one or more companies, etc. Additionally, the method may include identifying one or more affiliate companies associated with the one or more companies involved in the transaction, calculating a risk factor for the transaction based on a first risk level and a second risk level, the first risk level calculated based on the transaction information data, the second risk level calculated based on the company information data, and generating a notification for the user if a risk exposure is identified, where the risk exposure includes any transaction information data that matches to one of the user preferences. Further, the method may comprise displaying the notification to the user via the user device.

In this way, a user may be able to visualize company activity patterns so that the underlying motivations behind such activity may be elucidated. Specifically, company activity may be presented to a user on a geographic map. A user may further filter the company activity presented on the map, so that only certain, types of transactions, companies and/or persons involved with those transactions or customized alerts that are of interest to the user are shown on the map. By organizing company activity according to location, the activity patterns of a company or group of companies may be more transparent to a user, than by organizing the company activity in a list, table, or other form. Thus, the transparency of company activity is achieved by presenting activities involving one or more companies on a map.

In this way, systems and methods are also included for identifying companies that may be collaborating with one another. By identifying shared characteristics between companies, such as shareholders, interests, countries of origin, transactions, etc., companies that are collaborating with one another without public recognition may be identified. Further, the relationships between collaborating companies may be identified, so that it may become clearer how the interests of a company may be influenced by the companies they are associated with. As such, the accuracy of predictions of company activity may be increased by identifying the relationships between associated companies. Since a company may control one or more other companies, a more complete understanding of the sphere of influence of a company may be obtained. In this way, by associating a first company with one or more second companies, any actions taken by any of the second companies may automatically be tied to the first company. Said another way, for a given transaction, not only may the companies directly involved in the transaction be identified as being involved with the transaction, but so too may all companies associated or collaborating with the directly involved companies.

Therefore, by discovering and recognizing the associations between companies, and identifying these complex networks, the behavior of these networks, and therefore the companies themselves may be better understood. With an improved understanding of company behavior, a user may be better able to anticipate future company activity, and can therefore plan their own actions more effectively to minimize risk and/or harm to themselves and their institutions. Further, a user may establish their own risk criteria to specify which types of transactions, companies, locations, industries, etc., are of higher concern. Thus, in response to new company activity that meets the risk criteria of the user, an alert may be generated and sent to the user to notify the user of the potential risk. In this way, risks to a user may more accurately and immediately be identified. As such, the advancement of a user's own interests may be increased.

The above summary is provided to introduce a selection of concepts in a simplified form that are further described below in the Detailed Description. This summary is not intended to identify key features or essential features of the subject matter, nor is it intended to be used to limit the scope of the subject matter. Furthermore, the subject matter is not limited to implementations that solve any or all of the disadvantages noted above or in any part of this disclosure.

### BRIEF DESCRIPTION OF THE FIGURES

FIG. 1 illustrates an overview of an exemplary computing environment.

FIG. 2A shows a flow chart of a method for generating a notification based on company activity.

FIG. 2B shows a flow chart of a method for identifying associate companies affiliated with one or more companies.

FIG. 2C shows a flow chart of a method for determining if a transaction is a potential threat or risk.

FIG. 3 shows a flow chart of a method for displaying one or more of transactions, company office locations and customized alerts on a geographic map.

FIG. 4 shows a flow chart of a method for displaying transactions of one or more companies on a geographic map.

FIG. 5A illustrates an example tracking and visualization interface for a user.

FIG. 5B illustrates an example tracking and visualization interface for a user.

FIG. 5C illustrates an example tracking and visualization interface for a user.

FIG. 5D illustrates an example tracking and visualization interface for a user.

FIG. 5E illustrates an example tracking and visualization interface for a user.

FIG. 5F illustrates an example tracking and visualization interface for a user.

FIG. 5G illustrates an example tracking and visualization interface for a user.

FIG. 5H illustrates an example tracking and visualization interface for a user.

FIG. 6A illustrates an example tracking and visualization interface for a user.

FIG. 6B illustrates an example tracking and visualization interface for a user.

FIG. 6C illustrates an example tracking and visualization interface for a user.

FIG. 6D illustrates an example tracking and visualization interface for a user.

FIG. 7A illustrates an example tracking and visualization interface for a user.

FIG. 7B illustrates an example tracking and visualization interface for a user.

FIG. 7C illustrates an example tracking and visualization interface for a user.

FIG. 7D illustrates an example tracking and visualization interface for a user.

FIG. 7E illustrates an example tracking and visualization interface for a user.

FIG. 8 illustrates an example tracking and visualization interface for a user.

FIG. 9A illustrates an example tracking and visualization interface for a user.

FIG. 9B illustrates an example tracking and visualization interface for a user.

FIG. 9C illustrates an example tracking and visualization interface for a user.

FIG. 9D illustrates an example tracking and visualization interface for a user.

FIG. 10 illustrates an example tracking and visualization interface for a user.

FIG. 11A illustrates an example tracking and visualization interface for a user.

FIG. 11B illustrates an example tracking and visualization interface for a user.

FIG. 11C illustrates an example tracking and visualization interface for a user.

FIG. 11D illustrates an example tracking and visualization interface for a user.

### DETAILED DESCRIPTION

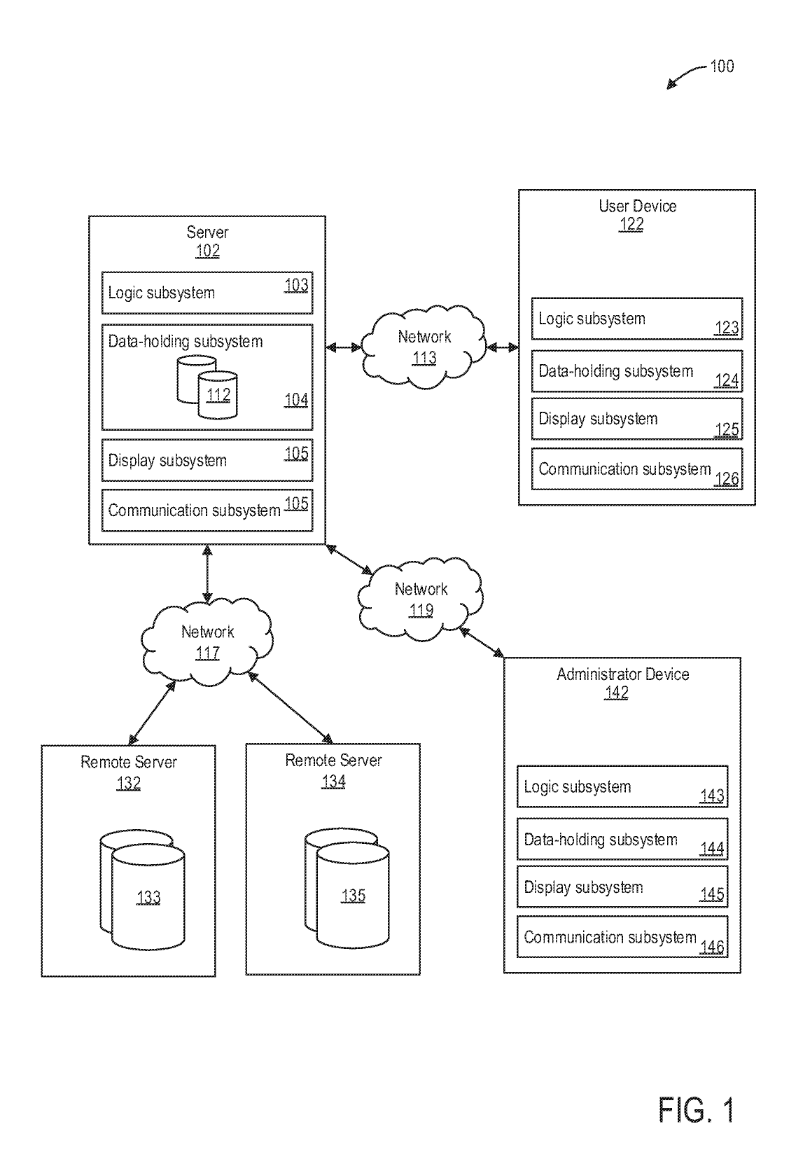

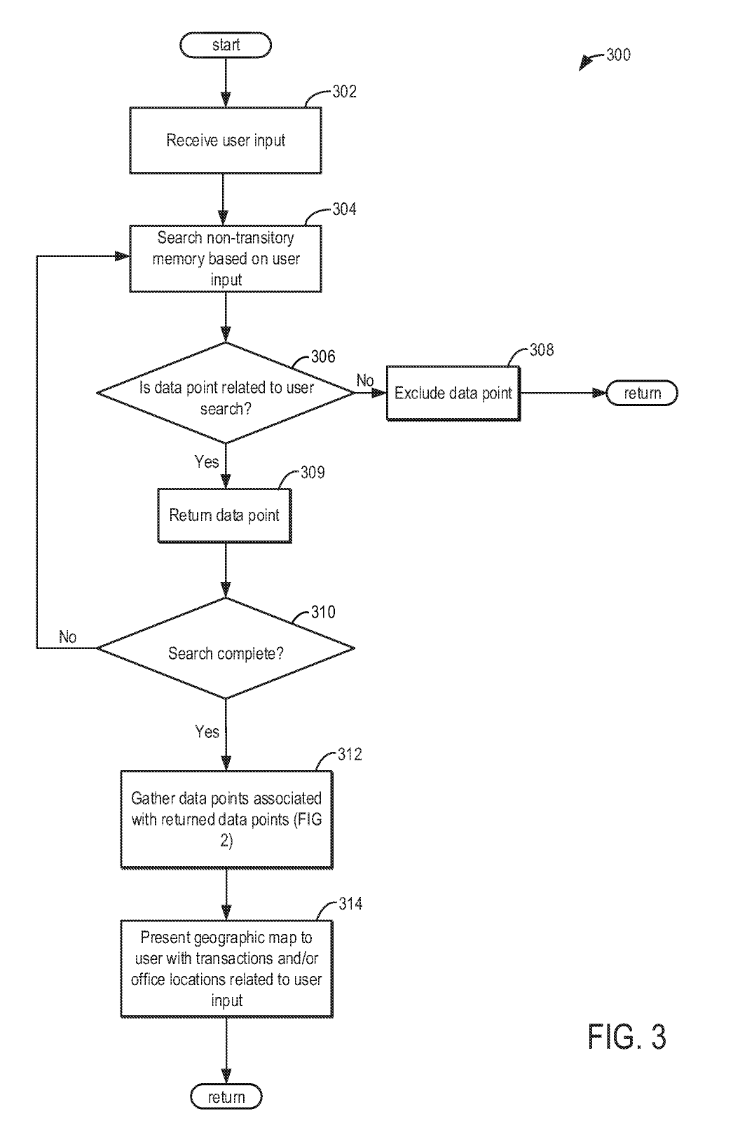

The following description relates to systems and methods for improving the transparency and visualization of company activity and behavior. When monitoring the activity of one or more companies, a user may access a server containing information regarding the one or more companies of interest through a user device such as a phone, tablet, computer, etc., as shown in FIG. 1. The server may be in wireless communication with the user device as shown in FIG. 1, which may allow a user, to search for, compare and analyze the activity of one or more companies. Further, the server may access information regarding the one or more companies from one or more remote server databases, and organize that data so that it may be presented to a user in a more transparent way than would be obtained from an ordinary user search generating a list of search results. Specifically the transactions and office locations involving companies may be plotted on a geographic map, so that the physical locations of all transactions and office locations may be visualized. The server may contain a logic subsystem which may be configured to perform a method such as the example methods of FIGS. 3-5, to carry out the company activity search requested by the user. As a result, increased transparency of company activity is achieved in variety of ways.

First, companies that are collaborating with one another, or are associated with one another in some way so as to provide mutual benefit, are identified as described in the method shown in FIG. 3. In some examples, a company may divide and/or share its assets with other companies (also referred to hereinafter as daughter companies) so that the company actions are not directly tied back to the company. In this way, a company's behavior and agenda can become obscured or concealed. However, by identifying associations between companies, and grouping associated companies together, the obfuscation of company activity may be reduced. Thus, a user may be able to visualize transactions, political actions, or other actions that a company is directly and/or indirectly responsible for through both its parent and daughter companies. As such, the sphere of influence of a company may be made more transparent to a user.

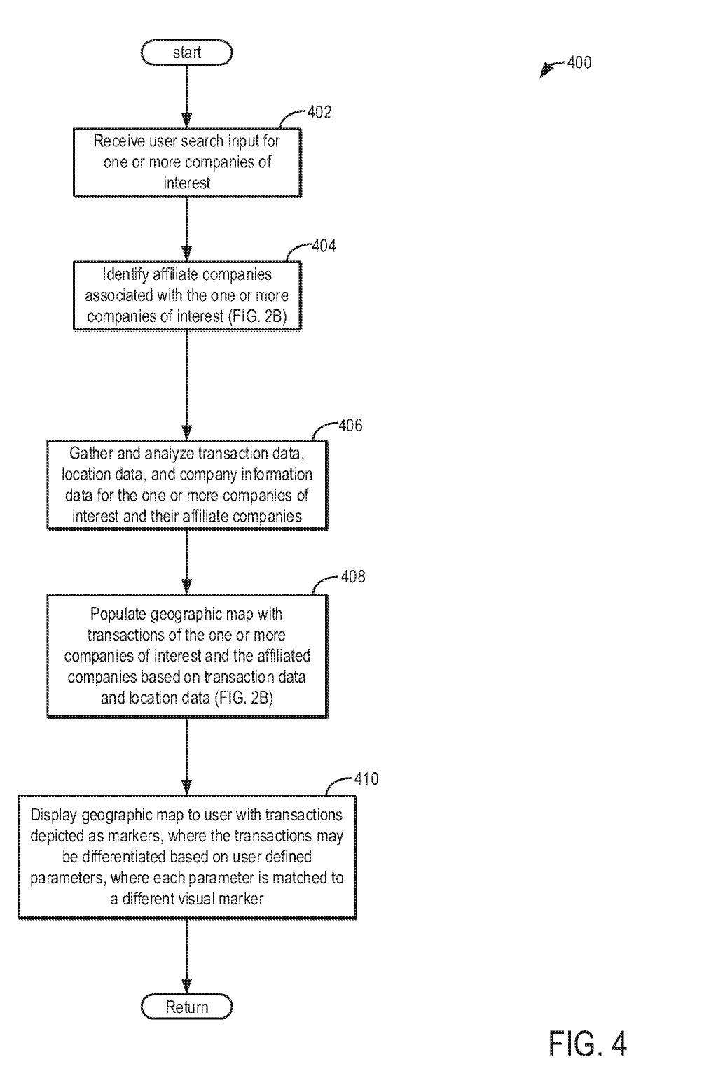

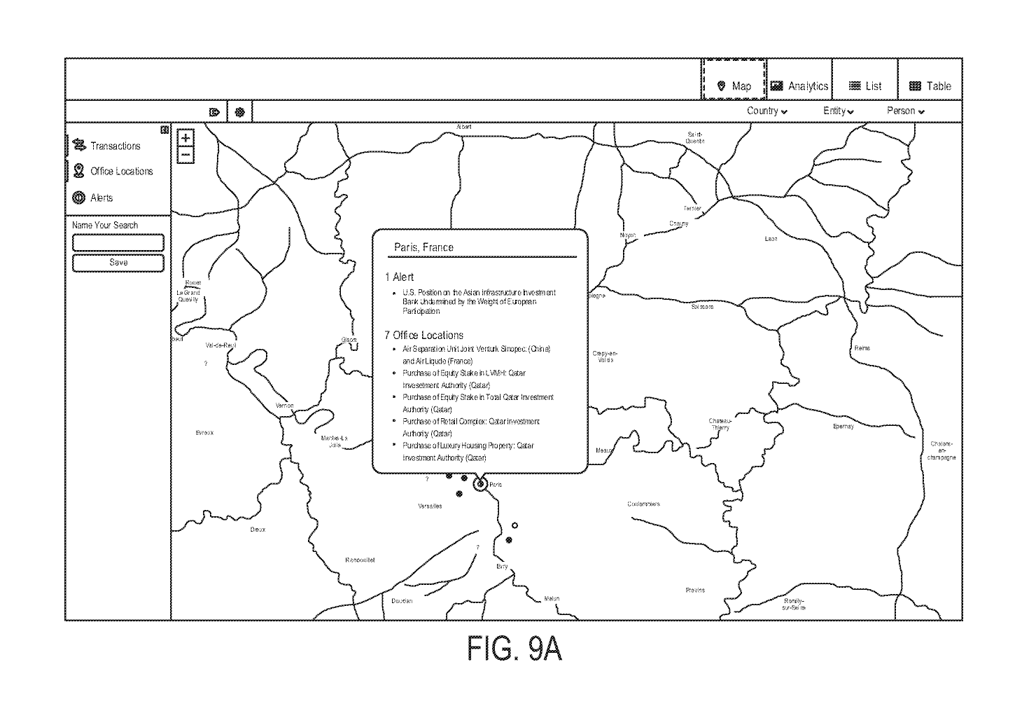

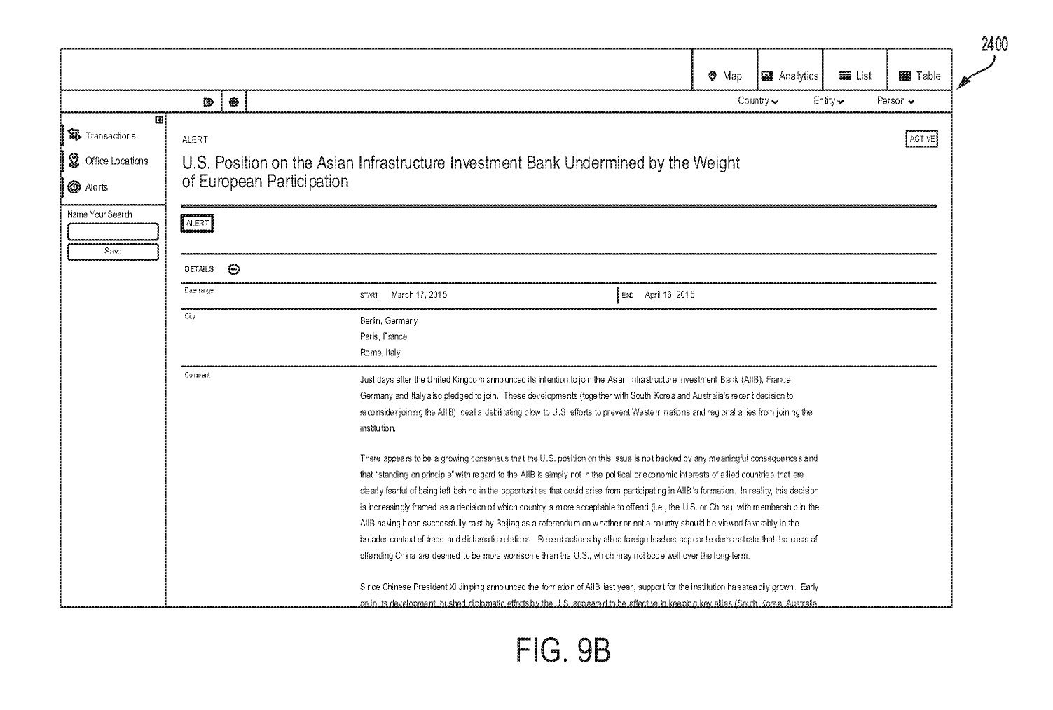

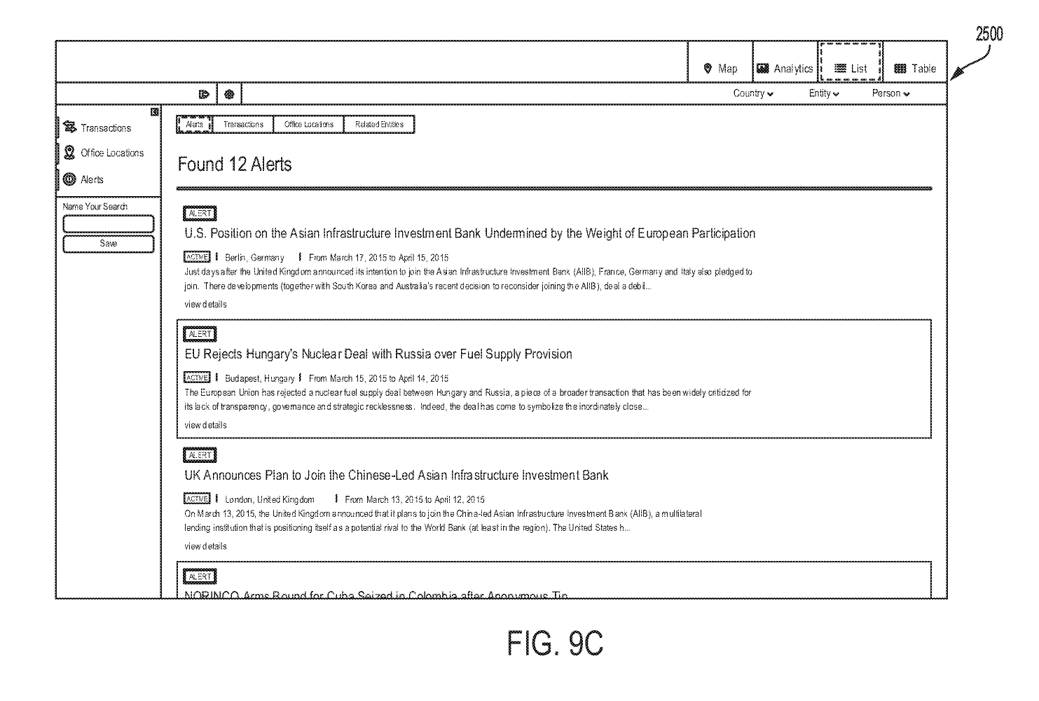

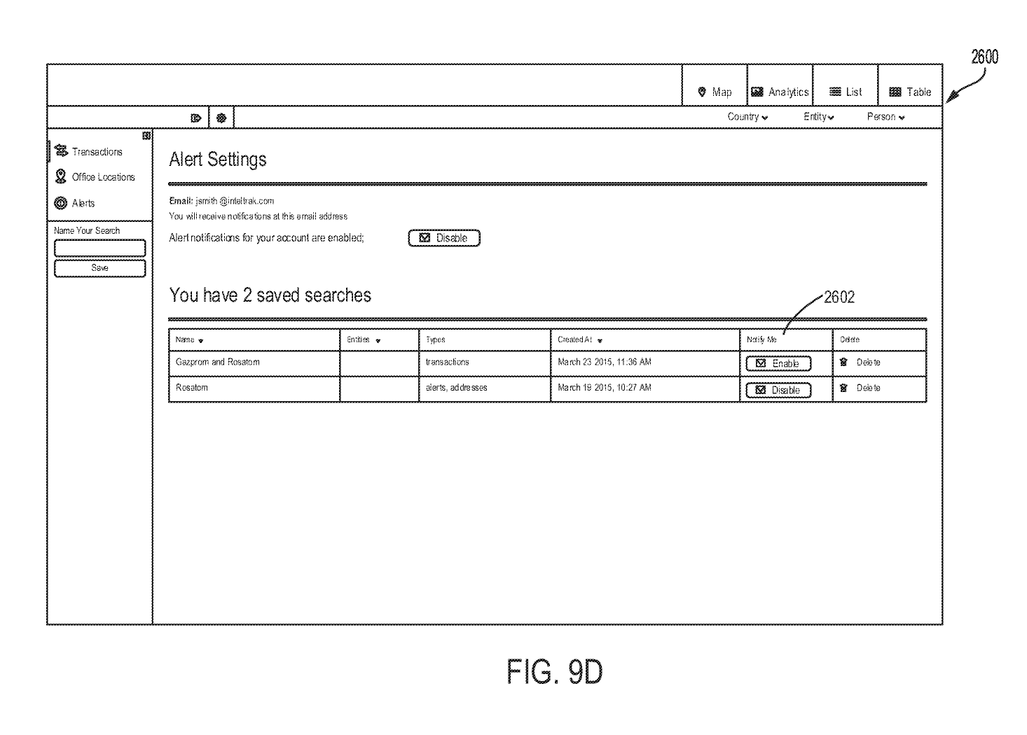

Second, any actions taken by a company that may be of significance to the user, may be recognized, and notified to the user as described in the method shown in FIG. 4. The notifications may be presented to a user via a user interface as shown in FIGS. 9A-9D. Additionally, a user may define how the notifications are generated. For example, a user may input companies, types of transactions, and/or locations that may be of special interest, so that notifications may be generated for any actions meeting the criteria defined by the user. Thus, a user may be made aware of, and may more quickly recognize an action taken by a company that could be a threat and/or risk to the user. In this way, a user my react more quickly to company actions, so that the security and risk management of the user may be enhanced.

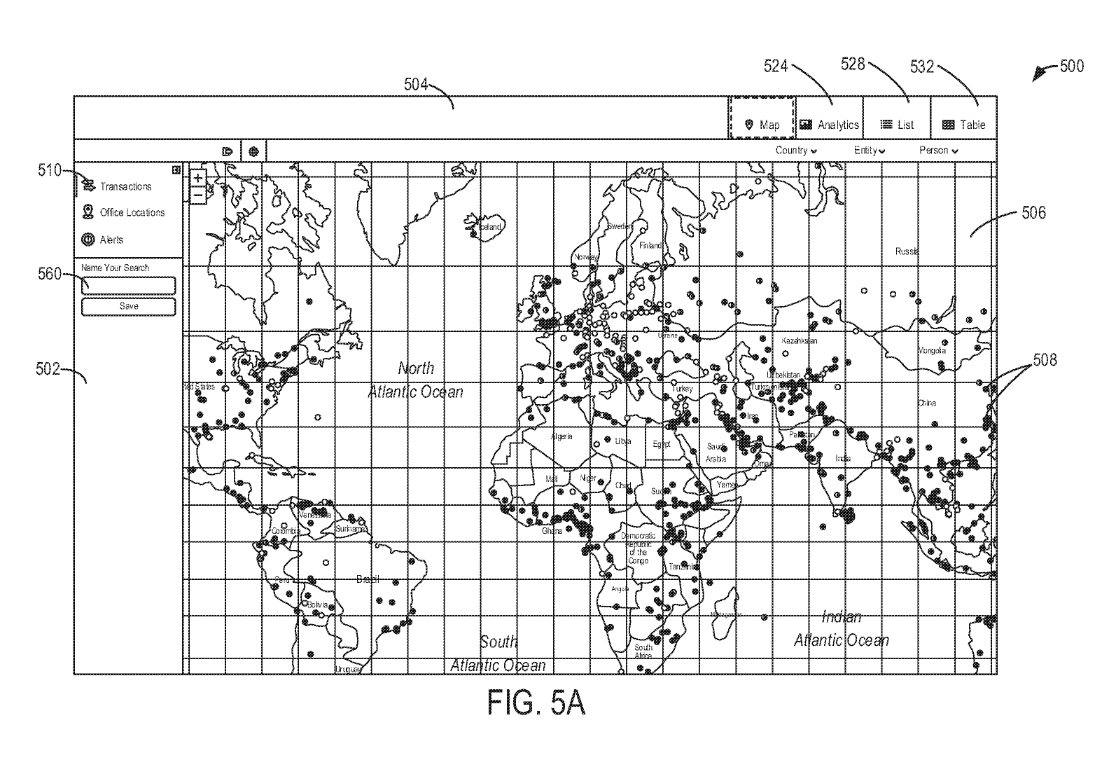

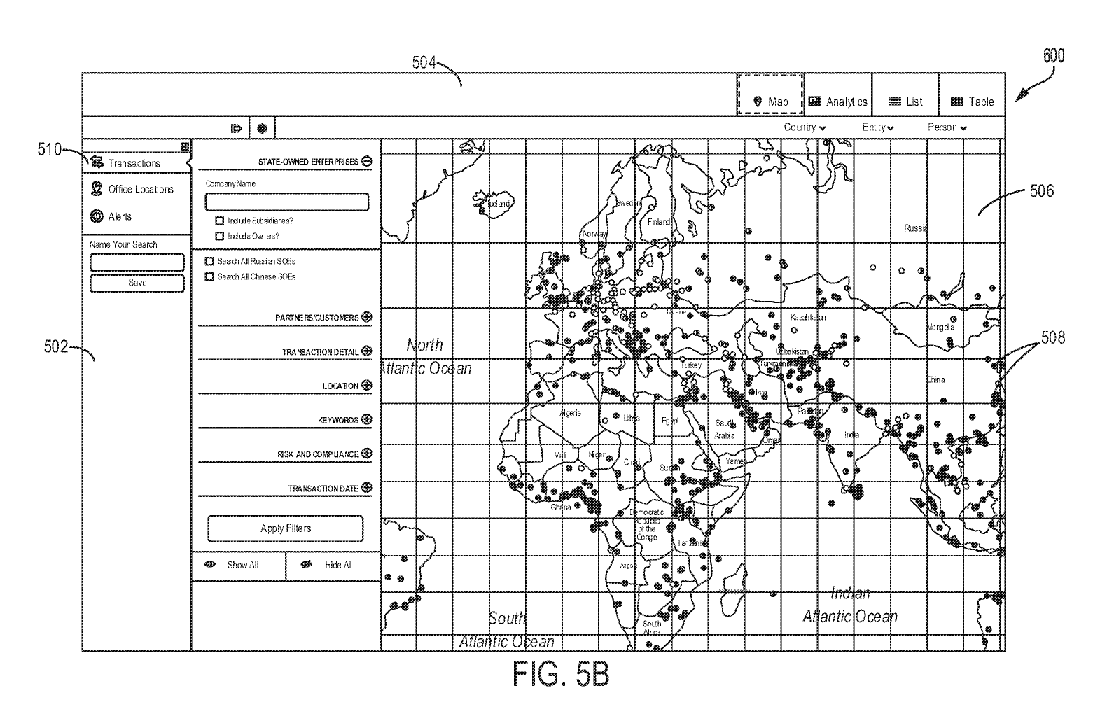

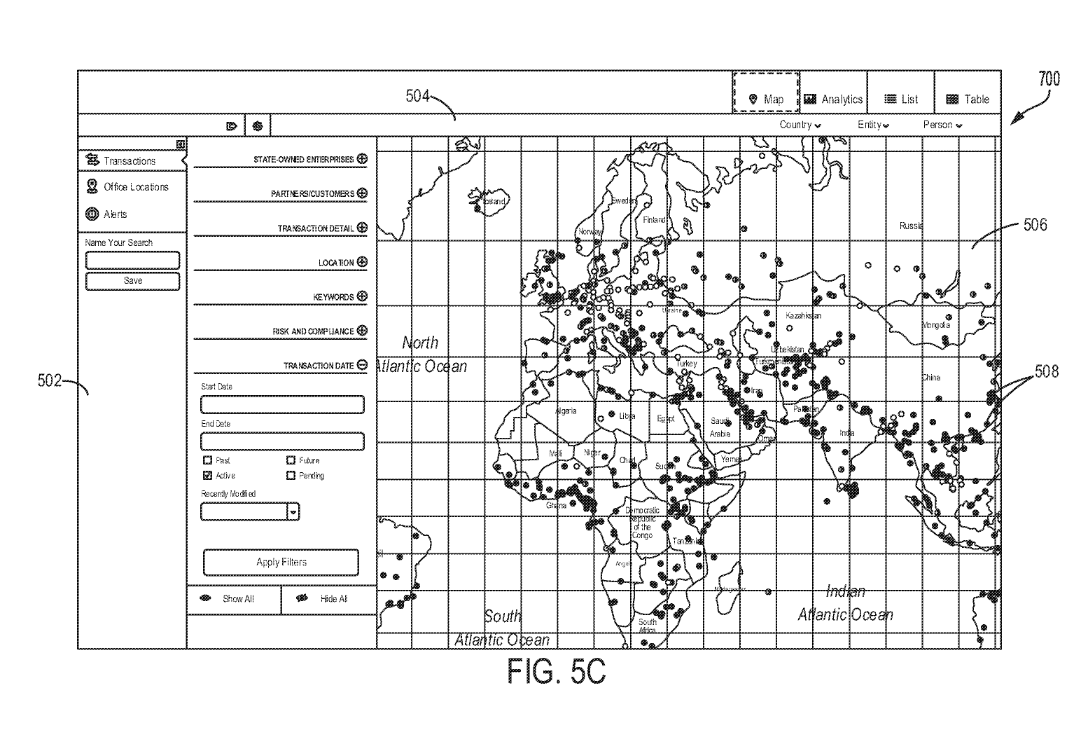

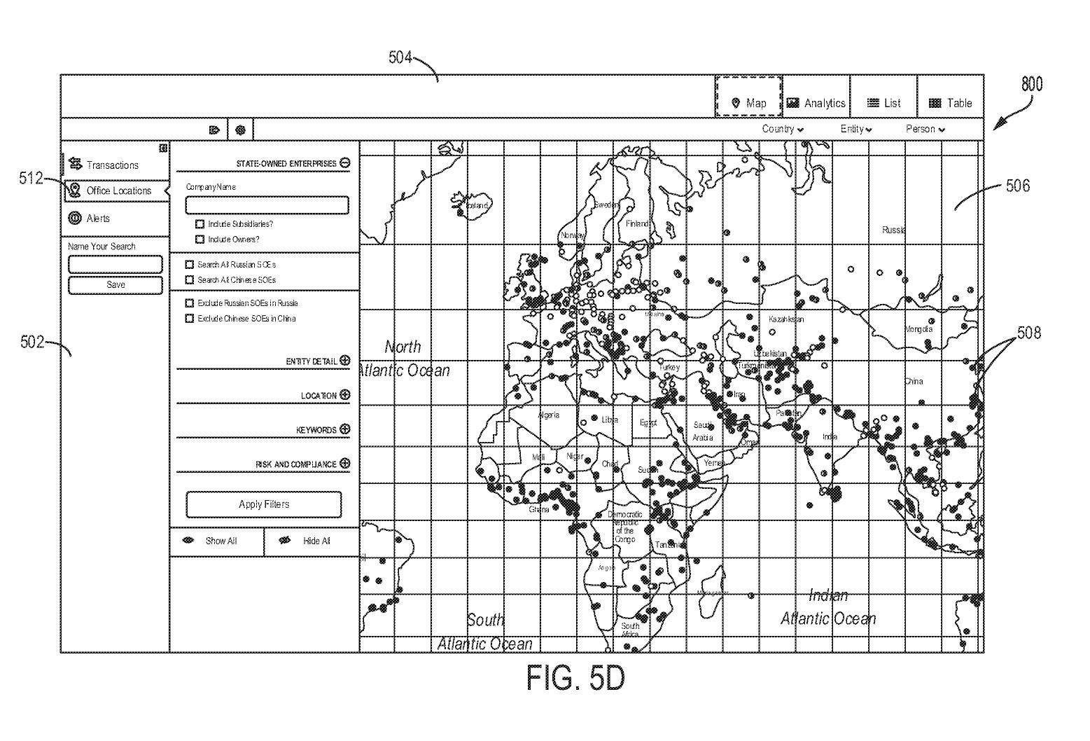

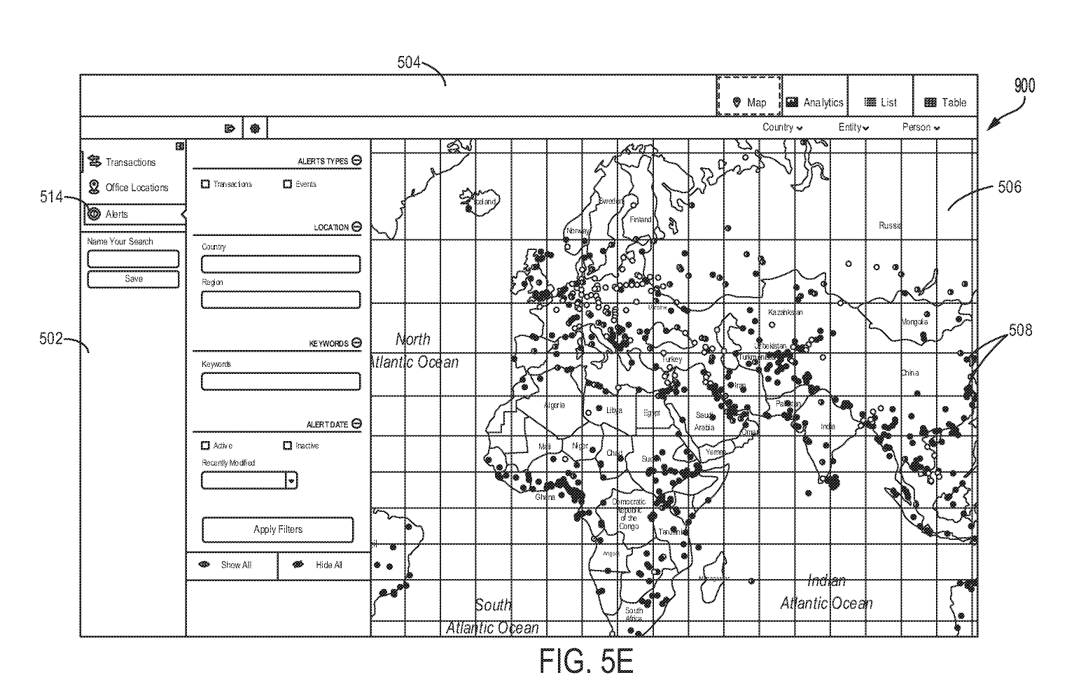

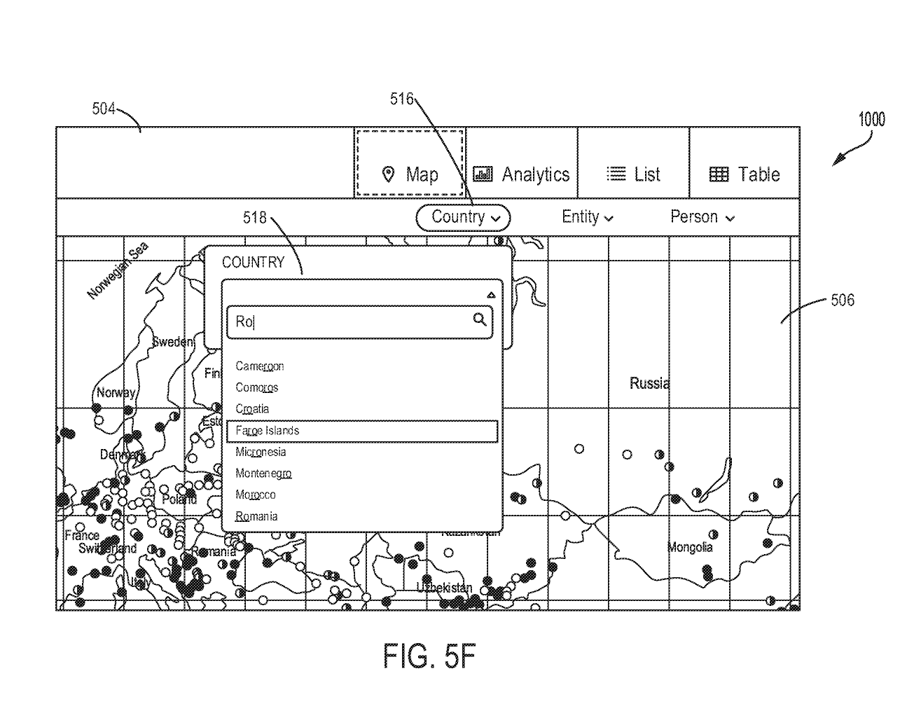

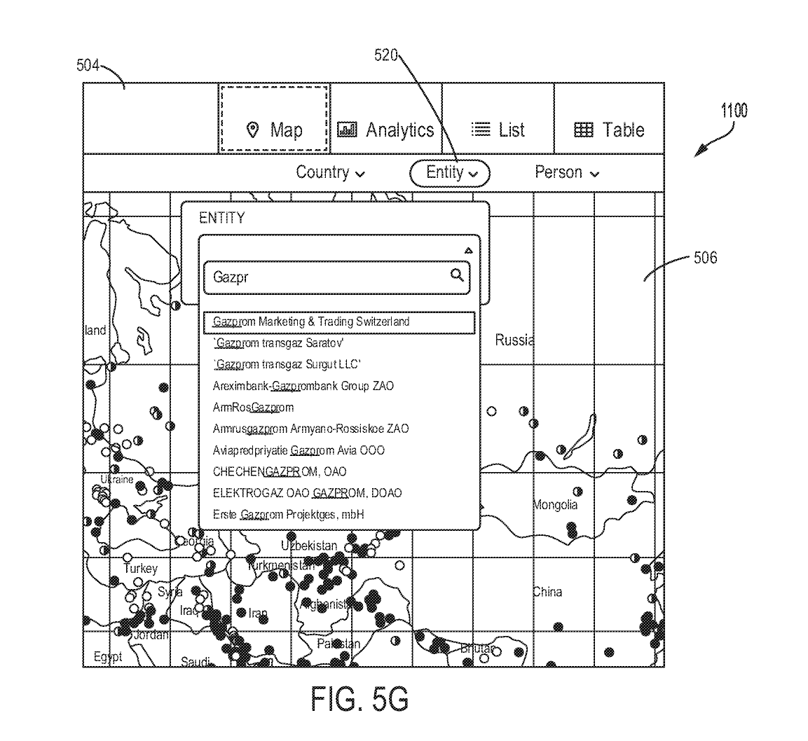

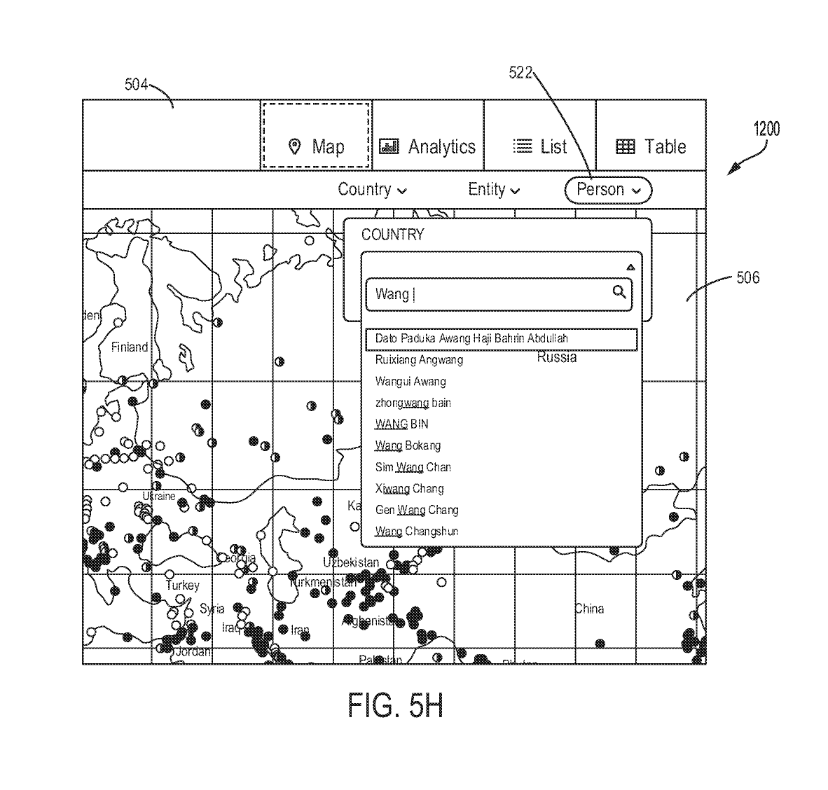

Third, company actions and office locations may be presented to a user on a geographic map as described in the method shown in FIG. 3-4. Specifically, a user may be presented with a user display, which in some examples may be a geographic map as shown in FIGS. 5A-5H. By overlaying company activity on the map, the locations, and therefore interests of the company, may be made more transparent to a user. As such, a user may more clearly be able to visualize where and for what purpose a company is directing their financial and/or political attention. Said another way, a company's motives and intentions may be made more transparent to a user by visualizing the location of transactions and events that a company is either partly or wholly involved with.

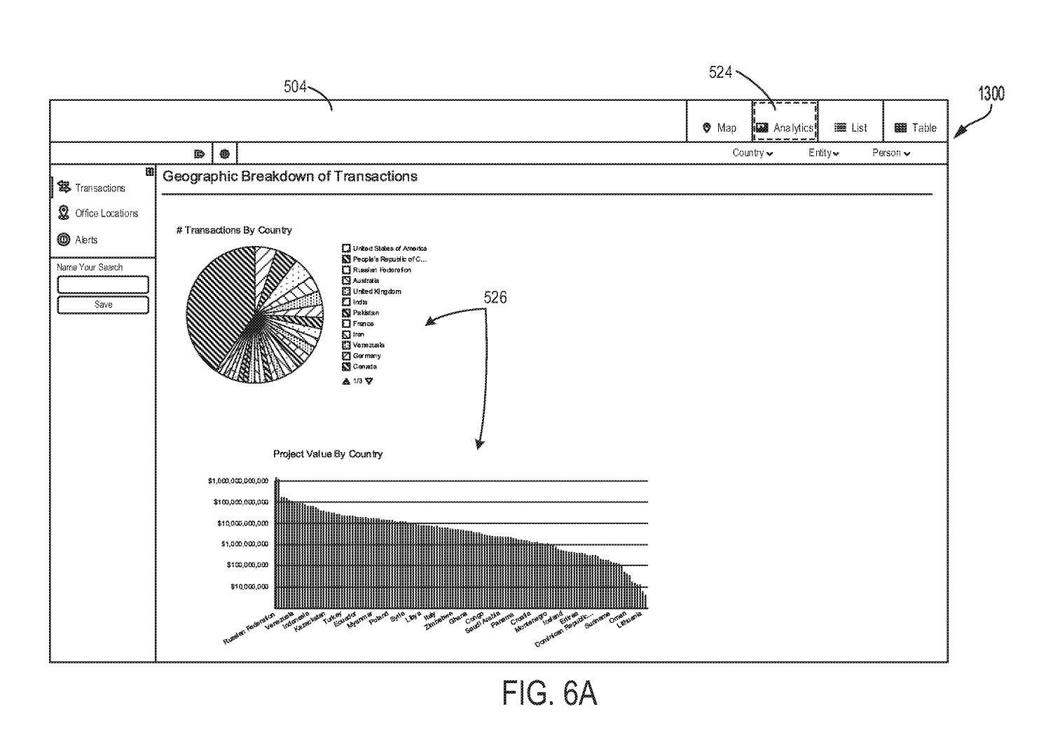

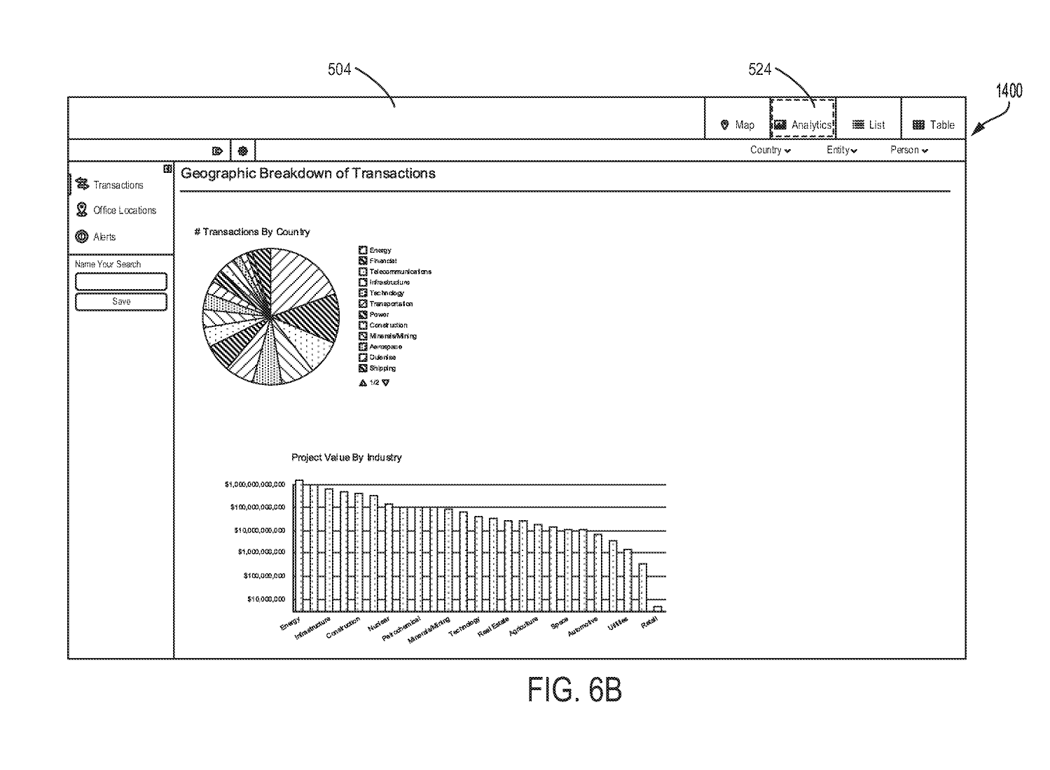

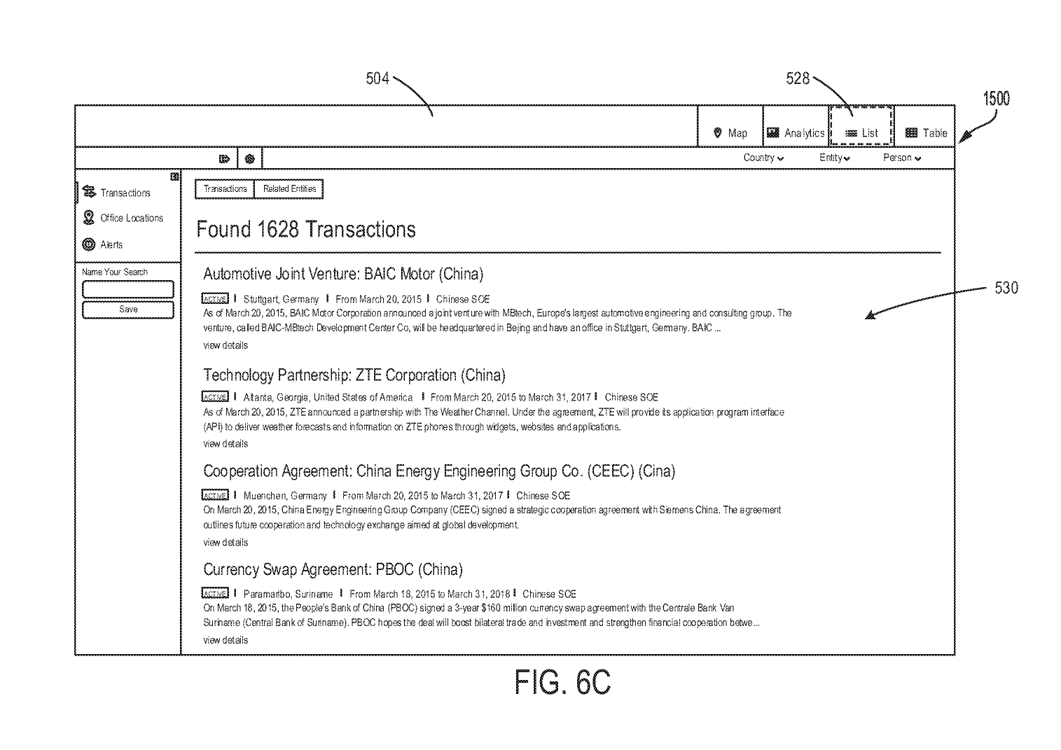

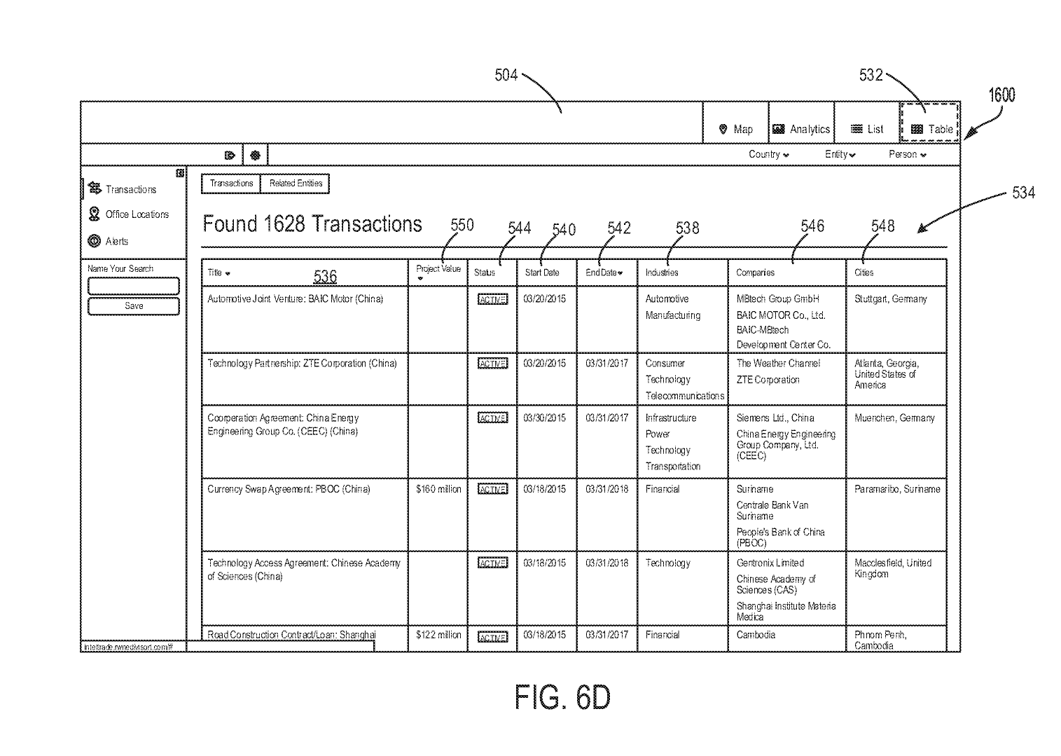

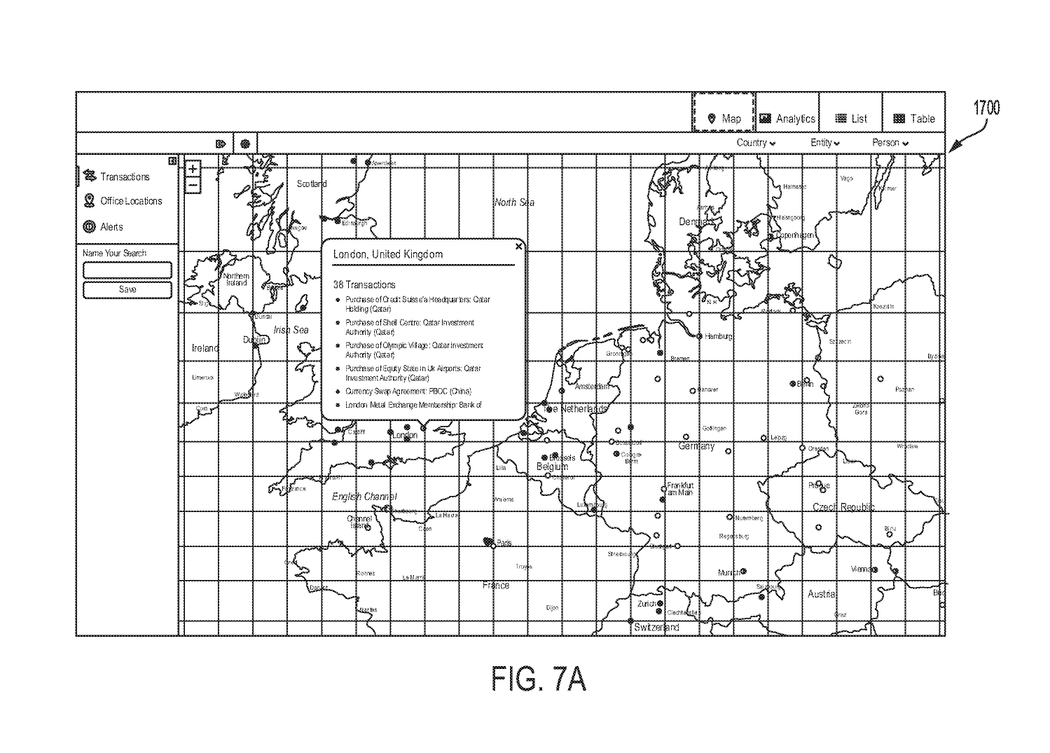

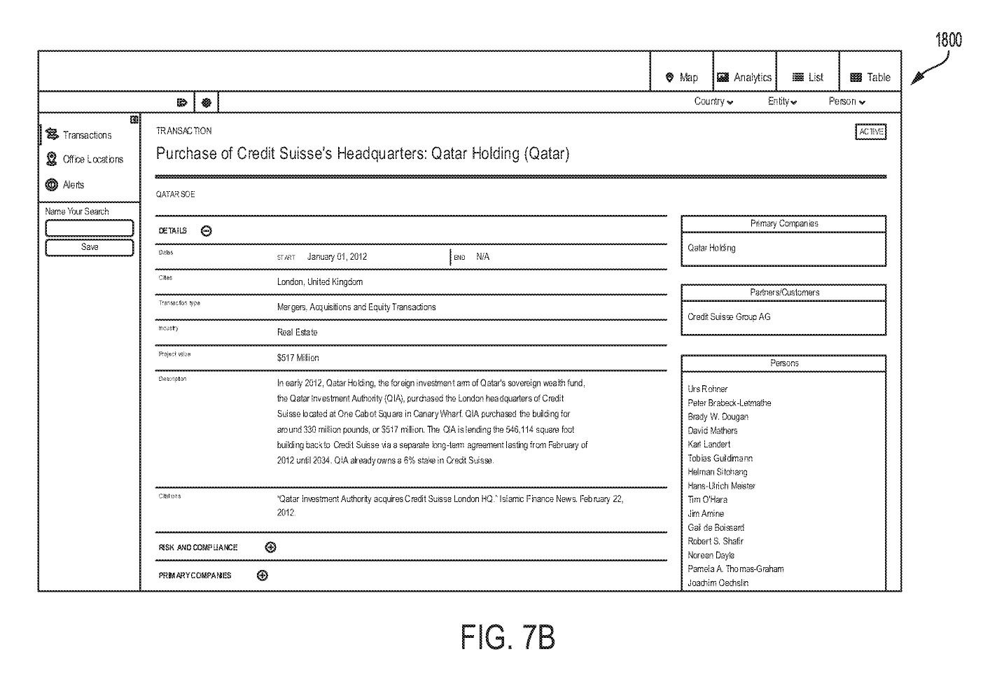

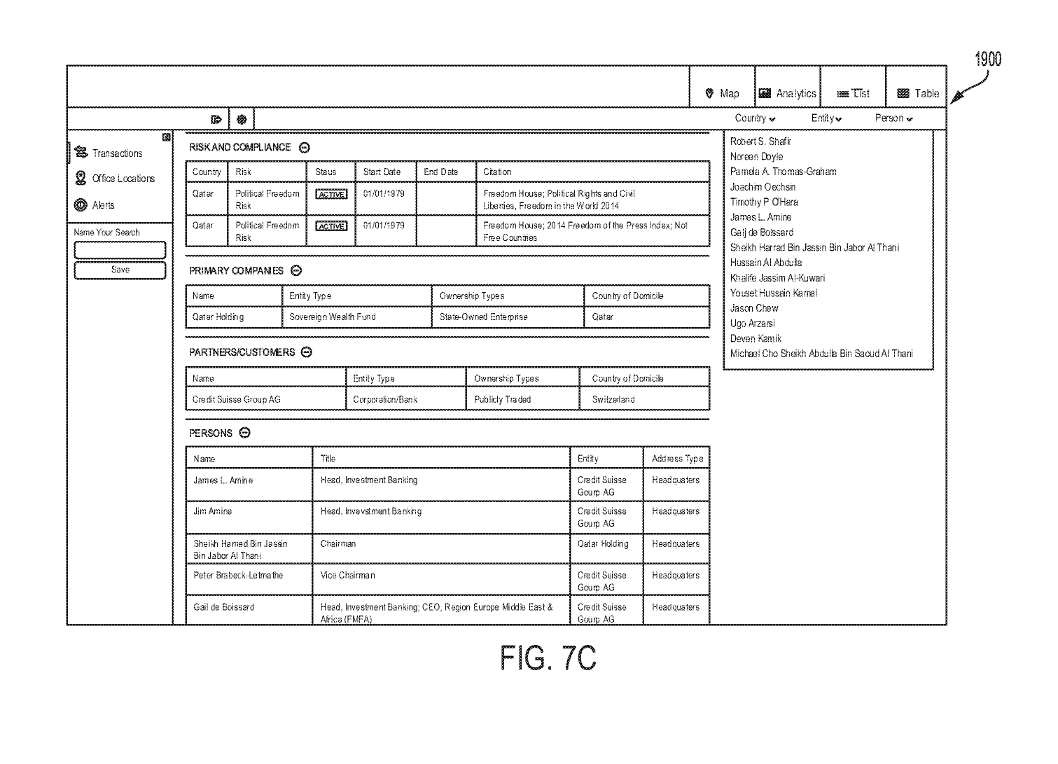

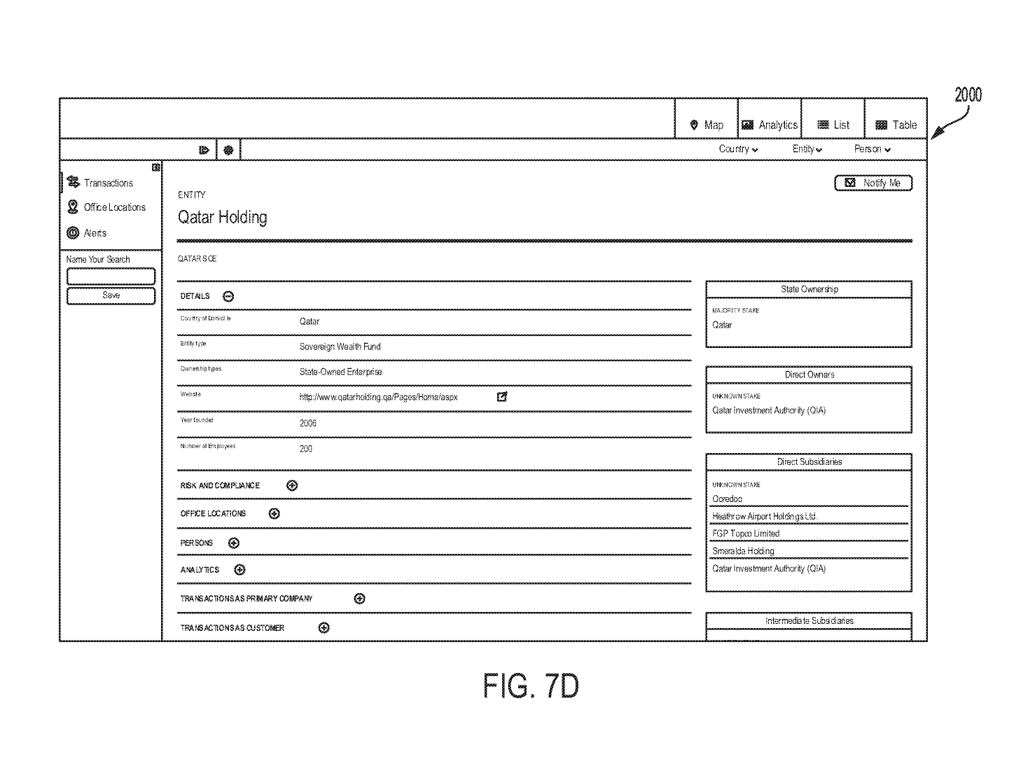

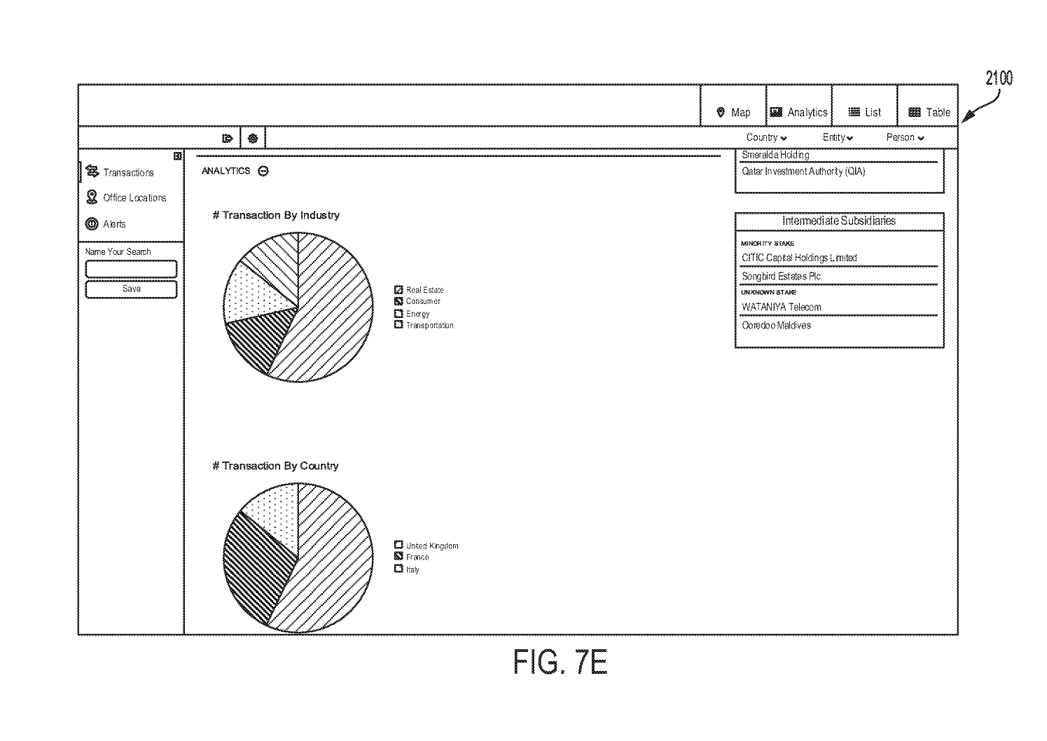

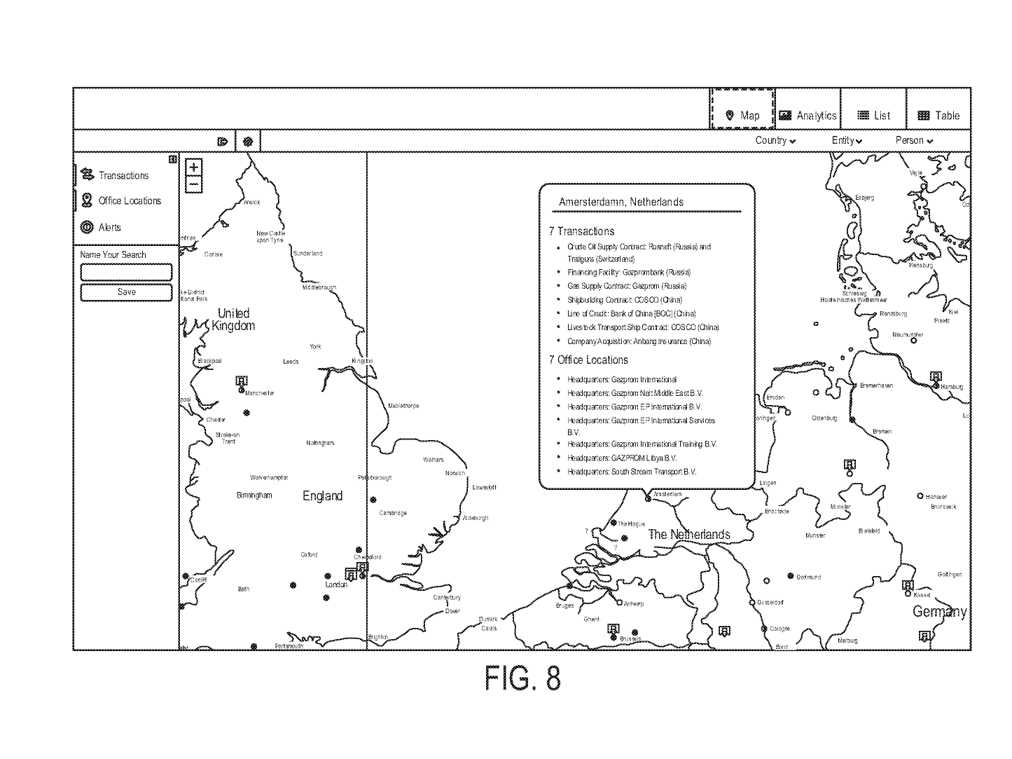

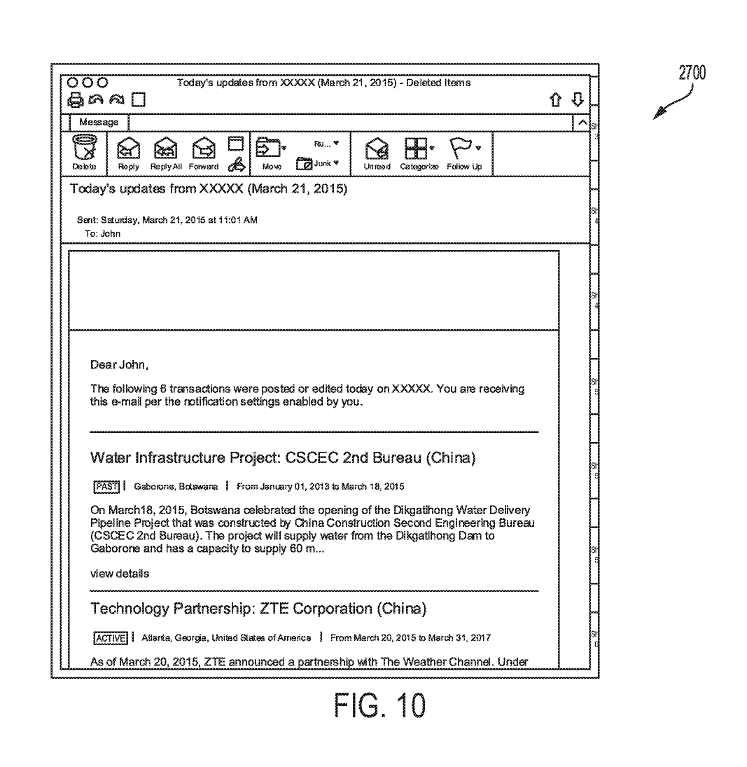

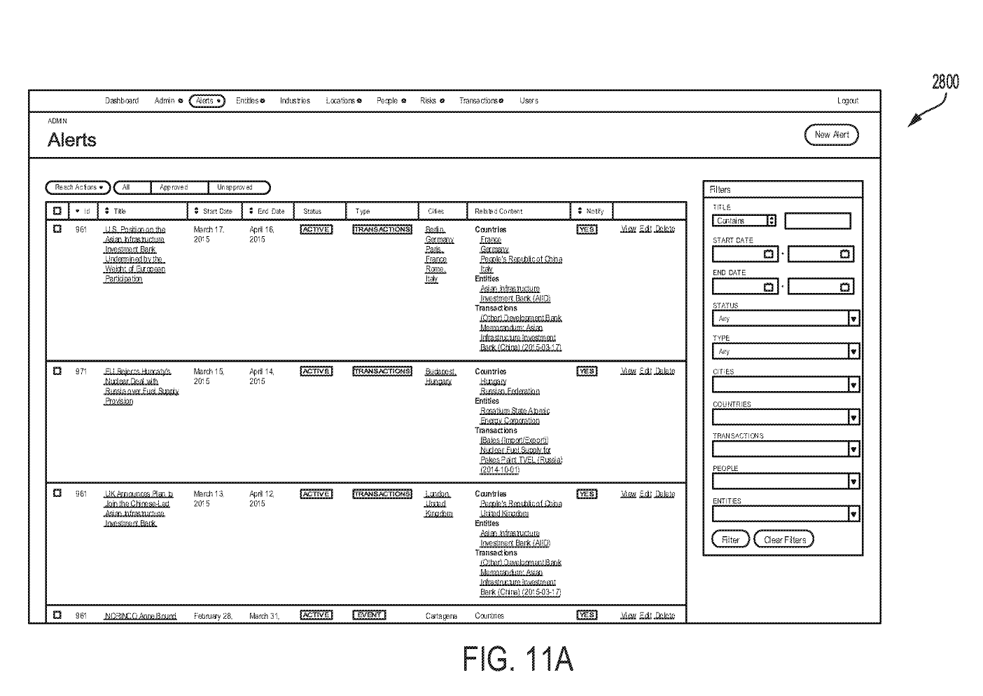

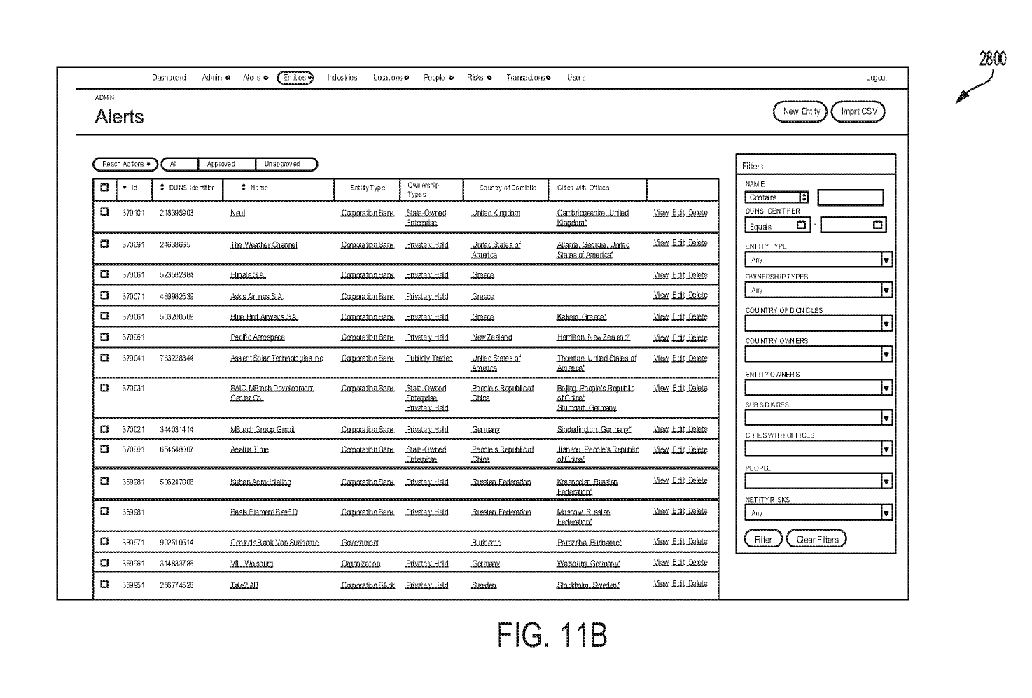

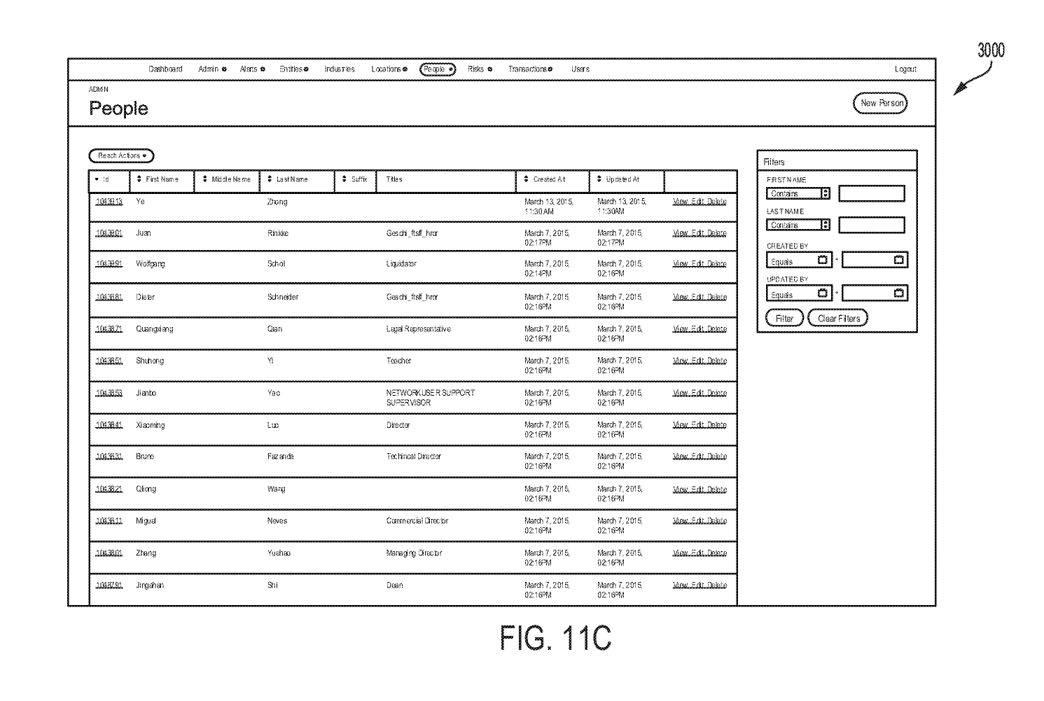

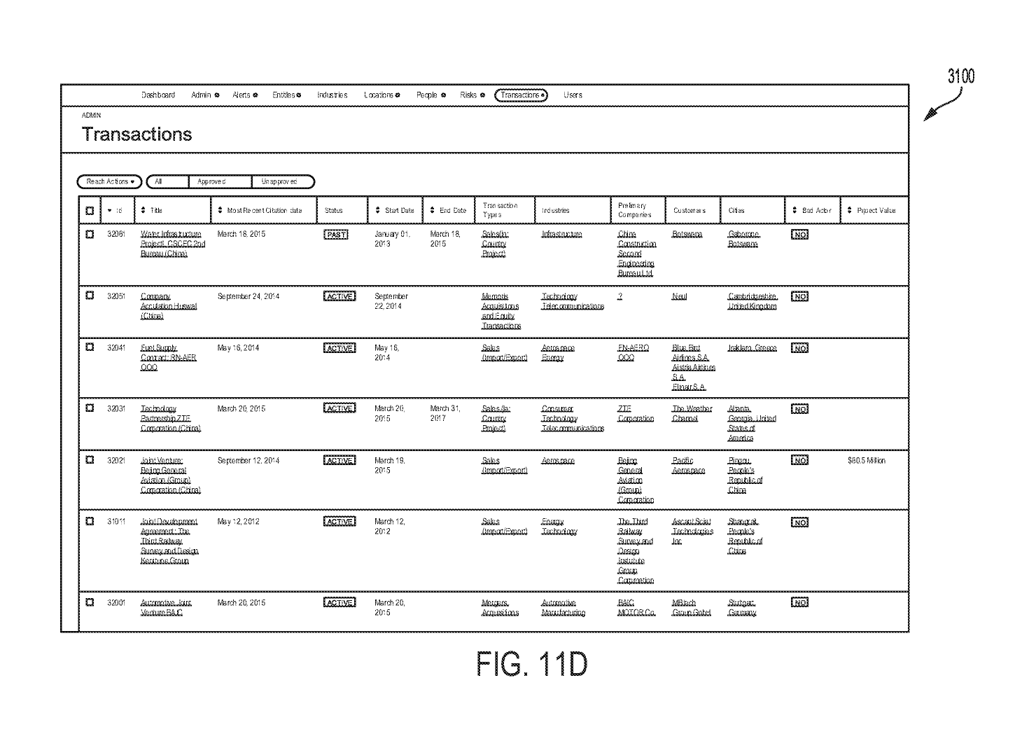

Additionally, as shown in FIGS. 5A-5H and 8A-8B, a user may filter companies and transactions presented on the user interface, so that only certain companies, persons associated with those companies, industry types, transactions, events, etc., are displayed on the user interface. Thus, a user may narrow search results presented on the user interface according to user preferences. A user may also search for specific companies, persons, transactions, locations, etc., as shown in FIGS. 7A-7E. In other examples, a user may also be provided with one or more graphs, lists, and tables, summarizing the results of their search as shown in FIGS. 6A-6D and 11A-11D. Further, a user may receive updates so as to be provided with the most current events and actions taken by one or more companies as shown in FIG. 10.

As such, the systems and methods described herein may provide additional advantages to previous attempts to address the lack of transparency of company behavior. First, company networks may be identified so that the ability to recognize company involvement in a given transaction may be increased. Thereby, the accuracy of estimated future company activity and behavior may be improved. Second, due to the geographical visualization of company activity, the transparency of a company's motives and agendas may be increased and an estimation of the company's future activity made more accurate. As a result of having a more accurate and clear picture of company interests and desires, the risk management and policy-making agenda of a user may be improved. Specifically, a user may be able to better predict future actions of one or more companies, and plan their own actions more effectively. Further, company activity may be tracked according to user specific risk criteria, and the user may receive personalized alerts that are tailored to their preferences. Therefore, the advancement of a user's interests and/or goals may be increased.

FIG. 1 illustrates an example computing environment 100 in accordance with the current disclosure. In particular, computing environment 100 includes a server 102, a user device 122, an administrator device 142, one or more remote servers 132 and 134, and networks 113 and 117. However, not all of the components illustrated may be required to practice the invention. Variations in the arrangement and type of the components may be made without departing from the spirit or scope of the invention.

Server 102 may be a computing device configured to: generate a geographic representation of company and/or state owned enterprise activity and further summarize the activity of one or more companies using one or more of graphs, lists, and tables. In some examples, the company activity may include one or more of events, transactions, office locations, political events, and customized alerts that a company is either partly or wholly involved with, etc. The customized alerts may include: political events such as civil unrest, newly imposed government regulations, natural disasters, illegal activities, allegations of corruption, military events, strategically significant business partnerships or economic agreements, company transactions that have special significance for public and private sector users, etc. The transactions may include: purchases, investments, Memorandums of Understanding; import/export agreements, loans, trades, acquisitions, new branch or office openings, mergers, partnerships, and the large-scale exchange of currency between one or more entities. Further the company activity may be based on one or more of available research, published financial and economic information, press releases, news, internet-based articles, etc. In different embodiments, server 102 may take the form of a mainframe computer, server computer, desktop computer, laptop computer, tablet computer, home entertainment computer, network computing device, mobile computing device, mobile communication device, gaming device, etc.

Server 102 includes a logic subsystem 103 and a data-holding subsystem 104. Server 102 may optionally include a display subsystem 105, communication subsystem 106, and/or other components not shown in FIG. 1. For example, server 102 may also optionally include user input devices such as keyboards, mice, game controllers, cameras, microphones, and/or touch screens.

Logic subsystem 103 may include one or more physical devices configured to execute one or more instructions. For example, logic subsystem 103 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 103 may include one or more processors that are configured to execute software instructions. Additionally or alternatively, the logic subsystem 103 may include one or more hardware or firmware logic machines configured to execute hardware or firmware instructions. Processors of the logic subsystem 103 may be single or multi-core, and the programs executed thereon may be configured for parallel or distributed processing. The logic subsystem 103 may optionally include individual components that are distributed throughout two or more devices, which may be remotely located and/or configured for coordinated processing. For example, the logic subsystem 103 may include several engines for processing and analyzing data. These engines may include a test evaluator engine, user comment engine, user review engine, user feedback engine, etc. These engines may be wirelessly connected to one or more databases for processing data from the databases. One or more aspects of the logic subsystem 103 may be virtualized and executed by remotely accessible networked computing devices configured in a cloud computing configuration.

Data-holding subsystem 104 may include one or more physical, non-transitory devices configured to hold data and/or instructions executable by the logic subsystem 103 to implement the herein described methods and processes. When such methods and processes are implemented, the state of data-holding subsystem 104 may be transformed (for example, to hold different data).

Data-holding subsystem 104 may include removable media and/or built-in devices. Data-holding subsystem 104 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 104 may include devices with one or more of the following characteristics: volatile, nonvolatile, dynamic, static, read/write, read-only, random access, sequential access, location addressable, file addressable, and content addressable. In some embodiments, logic subsystem 103 and data-holding subsystem 104 may be integrated into one or more common devices, such as an application-specific integrated circuit or a system on a chip.

It is to be appreciated that data-holding subsystem 104 includes one or more physical, non-transitory devices. In contrast, in some embodiments aspects of the instructions described herein may be propagated in a transitory fashion by a pure signal (for example, an electromagnetic signal) that is not held by a physical device for at least a finite duration. Furthermore, data and/or other forms of information pertaining to the present disclosure may be propagated by a pure signal.

When included, display subsystem 105 may be used to present a visual representation of data held by data-holding subsystem 104. As the herein described methods and processes change the data held by the data-holding subsystem 104, and thus transform the state of the data-holding subsystem 104, the state of display subsystem 105 may likewise be transformed to visually represent changes in the underlying data. Display subsystem 105 may include one or more display devices utilizing virtually any type of technology. Such display devices may be combined with logic subsystem 103 and/or data-holding subsystem 104 in a shared enclosure, or such display devices may be peripheral display devices.

When included, communication subsystem 106 may be configured to communicatively couple server 102 with one or more other computing devices, such as user device 122 and/or remote server 132. Communication subsystem 106 may include wired and/or wireless communication devices compatible with one or more different communication protocols. As non-limiting examples, communication subsystem 106 may be configured for communication via a wireless telephone network, a wireless local area network, a wired local area network, a wireless wide area network, a wired wide area network, etc. In some embodiments, communication subsystem 106 may allow server 102 to send and/or receive messages to and/or from other devices via a network such as the public Internet. For example, communication subsystem 106 may communicatively couple server 102 with user device 122 via network 113 and/or remote server 132 via network 117. In some examples, network 113 may be the public Internet. Furthermore, network 117 and network 119 may be regarded as private network connections and may include, for example, a virtual private network or an encryption or other security mechanism employed over the public Internet. In some examples, network 113 and network 117 may be the same network. In other examples, network 117 and 119 may be the same network. In still further examples, network 113 and 119 may be the same network.

Computing environment 100 may include one or more devices operated by users, such as user device 122. User device 122 may be any computing device configured to access a network such as network 113, including but not limited to a personal computer, a laptop, a smartphone, a tablet, and the like. In some examples, user device 122 may be a mapping device configured to display a two-dimensional map. Thus, the user device 122 may also be referred to herein as mapping device 122. The user device 122 therefore, may receive wireless data from server 102 corresponding to a two-dimensional graph, and the device 122 may convert the data from server 102 in a visual display that is a graphical representation of a map. Said another way, the device 122 may be a device that is specific to generating a two-dimensional map.

User device 122 includes a logic subsystem 123 and a data-holding subsystem 124. User device 122 may optionally include a display subsystem 125, communication subsystem 126, and/or other components not shown in FIG. 1. For example, user device 122 may also optionally include user input devices such as keyboards, mice, game controllers, cameras, microphones, and/or touch screens.

Logic subsystem 123 may include one or more physical devices configured to execute one or more instructions. For example, logic subsystem 123 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 123 may include one or more processors that are configured to execute software instructions. Additionally or alternatively, the logic subsystem 123 may include one or more hardware or firmware logic machines configured to execute hardware or firmware instructions. Processors of the logic subsystem 123 may be single or multi-core, and the programs executed thereon may be configured for parallel or distributed processing. The logic subsystem 123 may optionally include individual components that are distributed throughout two or more devices, which may be remotely located and/or configured for coordinated processing. One or more aspects of the logic subsystem 123 may be virtualized and executed by remotely accessible networking computing devices configured in a cloud computing configuration.

Data-holding subsystem 124 may include one or more physical, non-transitory devices configured to hold data and/or instructions executable by the logic subsystem 123 to implement the herein described methods and processes. When such methods and processes are implemented, the state of data-holding subsystem 124 may be transformed (for example, to hold different data).

Data-holding subsystem 124 may include removable media and/or built-in devices. Data-holding subsystem 124 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 124 may include devices with one or more of the following characteristics: volatile, nonvolatile, dynamic, static, read/write, read-only, random access, sequential access, location addressable, file addressable, and content addressable. In some embodiments, logic subsystem 123 and data-holding subsystem 124 may be integrated into one or more common devices, such as an application-specific integrated circuit or a system on a chip.

When included, display subsystem 125 may be used to present a visual representation of data held by data-holding subsystem 124. As the herein described methods and processes change the data held by the data-holding subsystem 124, and thus transform the state of the data-holding subsystem 124, the state of display subsystem 125 may likewise be transformed to visually represent changes in the underlying data. Display subsystem 125 may include one or more display devices utilizing virtually any type of technology. Such display devices may be combined with logic subsystem 123 and/or data-holding subsystem 124 in a shared enclosure, or such display devices may be peripheral display devices.

When included, communication subsystem 126 may be configured to communicatively couple user device 122 with one or more other computing devices, such as server 102. Communication subsystem 126 may include wired and/or wireless communication devices compatible with one or more different communication protocols. As non-limiting examples, communication subsystem 126 may be configured for communication via a wireless telephone network, a wireless local area network, a wired local area network, a wireless wide area network, a wired wide area network, etc. In some embodiments, communication subsystem 126 may allow user device 122 to send and/or receive messages to and/or from other devices, such as server 102, via a network 113 such as the public Internet.

Similarly, when included, administrator device 142 includes a logic subsystem 143 and a data-holding subsystem 144. Administrator device 142 may optionally include a display subsystem 145, communication subsystem 146, and/or other components not shown in FIG. 1. For example, administrator device 142 may also optionally include user input devices such as keyboards, mice, game controllers, cameras, microphones, and/or touch screens.

Logic subsystem 143 may include one or more physical devices configured to execute one or more instructions. For example, logic subsystem 143 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 143 may include one or more processors that are configured to execute software instructions. Additionally or alternatively, the logic subsystem 143 may include one or more hardware or firmware logic machines configured to execute hardware or firmware instructions. Processors of the logic subsystem 143 may be single or multi-core, and the programs executed thereon may be configured for parallel or distributed processing. The logic subsystem 143 may optionally include individual components that are distributed throughout two or more devices, which may be remotely located and/or configured for coordinated processing. One or more aspects of the logic subsystem 143 may be virtualized and executed by remotely accessible networking computing devices configured in a cloud computing configuration.

Data-holding subsystem 144 may include one or more physical, non-transitory devices configured to hold data and/or instructions executable by the logic subsystem 143 to implement the herein described methods and processes. When such methods and processes are implemented, the state of data-holding subsystem 144 may be transformed (for example, to hold different data).

Data-holding subsystem 144 may include removable media and/or built-in devices. Data-holding subsystem 144 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 144 may include devices with one or more of the following characteristics: volatile, nonvolatile, dynamic, static, read/write, read-only, random access, sequential access, location addressable, file addressable, and content addressable. In some embodiments, logic subsystem 143 and data-holding subsystem 144 may be integrated into one or more common devices, such as an application-specific integrated circuit or a system on a chip.

When included, display subsystem 145 may be used to present a visual representation of data held by data-holding subsystem 144. As the herein described methods and processes change the data held by the data-holding subsystem 144, and thus transform the state of the data-holding subsystem 144, the state of display subsystem 145 may likewise be transformed to visually represent changes in the underlying data. Display subsystem 145 may include one or more display devices utilizing virtually any type of technology. Such display devices may be combined with logic subsystem 143 and/or data-holding subsystem 144 in a shared enclosure, or such display devices may be peripheral display devices.

When included, communication subsystem 146 may be configured to communicatively couple administrator device 142 with one or more other computing devices, such as server 102. Communication subsystem 146 may include wired and/or wireless communication devices compatible with one or more different communication protocols. As non-limiting examples, communication subsystem 146 may be configured for communication via a wireless telephone network, a wireless local area network, a wired local area network, a wireless wide area network, a wired wide area network, etc. In some embodiments, communication subsystem 146 may allow administrator device 142 to send and/or receive messages to and/or from other devices, such as server 102, via a network 119 such as the public Internet.

Similarly, remote server 132 may comprise a computing device communicatively coupled to server 102 via network 117. In some examples, the remote server 132 may include a plurality of remote servers, such as a financial claims server, transactions server, stock market trade database server, financial institution servers, current events server, third party data collection server, etc., all coupled to server 102 via network 117. The one or more remote servers included in remote server 132 may each include one or more databases 133. Thus, in one example, remote server 132 may include one or more transactions servers that contain one or more databases 133 with raw financial transaction information data, where the raw financial transaction information data may include information regarding approved transactions between two or more parties that involve a monetary exchange.

In other embodiments, remote server 132 may in some examples additionally and/or optionally include one or more current events servers that contain one or more study databases with raw published business, political, and national news, which may include information regarding recent transactions involving, but not limited to, companies and state owned enterprises. For the purposes of simplicity, in the description herein, companies and state owned enterprises may collectively be reference to as companies. Thus, in the description herein, “companies” may be used to refer to both privately owned businesses, companies and corporations, as well as state owned enterprises.

In still further example embodiments, the remote server 132 may further include one or more financial institution servers that contain one or more databases with raw fund transfer data. However, in some examples, the financial institution servers may not be included in the remote server 132. Thus the remote server 132 may include one or more servers each containing one or more databases that include information relating to the economic and political activity of a plurality of state owned enterprises and companies.

Similarly, remote server 134 may comprise a computing device communicatively coupled to server 102 via network 117. Remote server 134 may be the same or similar to remote server 132. As such, remote server 134 may comprise one or more databases 135, holding information. For example, the remote server 134 may store company activity records, company transaction records, company histories, including one or more of hiring records, gross yearly profits. Further, the remote server 134 may comprise one or more of graphs, charts, tables, etc., that organize that company activity records and histories. For example, the graphs, charts, tables, etc., may track transactions over time, by the transaction location, by transaction cost, by frequency of the transactions, etc. In this way, transactions for a company may be stored in the remote server 134. Further, a risk level for a company may be stored in the remote server 134. However, in other examples, the company activity records, and risk level may alternatively or additionally be stored in remote server 132 or in server 102.

Thus server 102, user device 122, administrator device 142, and remote servers 132 and 134 may each represent computing devices which may generally include any device that is configured to perform computation and that is capable of sending and receiving data communications by way of one or more wired and/or wireless communication interfaces. Such devices may be configured to communicate using any of a variety of network protocols. For example, user device 122 may be configured to execute a browser application that employs HTTP to request information from server 102 and then displays the retrieved information to a user on a display. Example interfaces that may be delivered to user device 122 from server 102 in such a manner and displayed, for example, on display subsystem 125 are described further herein and with regard to FIGS. 5A-8H.

Server 102 may collect and process data from remote servers 132 and 134, administrator device 142, and from user device 122. A user may input any preferences they may have pertaining to perceived threats and/or risks. For example, a user may input a particular state owned enterprise or company that they think poses more than a threshold amount of risk. For example, a state owned enterprise may be more than a threshold amount of risk if it is sanctioned by one or more of countries. In yet further examples, the user may adjust the risk level assigned to a company or state owned enterprise. In other examples, a user may input certain types of activities and/or transactions they deem to be of more than a threshold amount of risk. In still further examples, the user may input geographical locations and/or regions that the user regards as particularly hostile and/or of strategic importance. Thus the user preferences may include geographic locations, state owned enterprises, companies, persons, types of transactions, etc. Further, the user may select a degree of risk to be assigned to a particular geographic region, city, country etc., in which transactions occur. A user may select a degree of risk to be assigned to a particular company. Still further, a user may select a degree of risk to be assigned to types of transactions, industry of the transactions, amount of the transaction, etc. User information may be transferred to server 102 via network 113, and may be stored in the data-holding subsystem 104 of the server 102.

Additionally, an administrator may monitor one or more of the information received by the server 102 from the user device 122 and the remote server 132. Further, in some examples the administrator may monitor and adjust information being sent to the user device 122 from the server 102. In still further examples, an administrator may determine the risk level of a transaction and/or event via the administrator device 142. For example, the administrator may review current transactions and/or events processed by the server 102, and may determine that a transaction and/or event is more than a threshold risk to the user based on the user preferences, and may send a signal to the server 102 via the administrator device 142 to generate a notification to be presented to the user via the user device 122. In other examples, the administrator may determine that a notification generated by the server 102, does not need to be sent to the user based on the user preferences, and may therefore send a signal to the server 102 via the administrator device 142 to not send the notification to the user device 122.

Server 102 may analyze the data collected from user device 122 and remote server 132 using, for example, data analysis techniques and/or artificial intelligence techniques. Thus, user preferences received from the user via the user device 122 may be stored in the server 102, for example in data-holding subsystem 104. The server 102, may then continuously or periodically monitor new transaction information and activity information received from remote server 132 relating to new or current transactions, company activity, news, etc. Thus, the server 102, may pull current event news, transaction data, and company activity data from remote server 132, and analyze the information based on the stored user preferences. In particular, the server 102 may determine a first risk level for each new company activity and/or transaction received in the transaction data and/or company activity data from the remote server 132 based on the stored user preferences.

The risk level may be determined based on whether the new transaction and/or activity information match the user preferences. For example, if a user has set their preferences such that transactions in China are high risk, then the risk level for a transaction in China may be higher than a transaction in another country. In another example, if a user has set their preferences such that transactions over a threshold dollar value are high risk, then the risk level for a transaction with a dollar value over the threshold set by the user may be assigned a higher risk level than a transaction under the threshold. In yet further examples, if a user has set their preferences such that a company, such as Rosatom, is high risk, then a transaction involving Rosatom may be assigned a higher risk level than a transaction not involving Rosatom. In another example, a user may assign a higher risk level to transactions in a particular industry, for example oil. Thus, transactions in the oil industry may receive a higher risk level than transactions not in the oil industry. It should be appreciated that the risk level assigned by a user to geographic locations where transactions take place, the type of transaction, industry, dollar amount, companies involved, etc., may be in a range of risk levels. Thus, the user may assign a plurality of different, varying risk levels to various parameters of a transaction, such as the industry, companies involved, date, geographic region, monetary value, etc. The transaction parameters may include one or more of the dollar amount of the transaction, industry of the transaction, companies involved in the transaction, geographic location of the transaction, date of the transaction, type of transaction (e.g., purchase, sell, trade, merger, acquisition, etc.)

The first risk level for a transaction may increase for a number of matches between the transaction parameters of the transaction and the user preferences, and/or for an amount of risk assigned to each of the transaction parameters by the user in the user preferences that match to the transaction parameters of the transaction. For example, a transaction that occurs in a high risk region defined by the user, and involves a high risk company defined by the user, may be assigned a higher first risk level, than a transaction occurring in the high risk region but not involving the high risk company. Further, a transaction that occurs in a higher risk region defined by the user than a lower risk region may be assigned a higher first risk level. Thus, based on the user preferences, an amount of risk for a transaction may be determined based on an amount of similarity between the transaction and the user preferences.

For example, data collected from the one or more databases 133 in remote server 132 may be analyzed to determine certain aspects of a particular transaction, which may include one or more of the companies and/or state owned enterprises involved in the transaction, geographic location of the transaction, monetary amount of the transaction, date and time of the transaction, etc. Thus, in some examples, the server 102 may collect data from the remote server 132 periodically, or at certain intervals. For example, the server may collect data from the remote server 132 after a certain amount of time has passed since the most recent collection of data from the remote server 132. Thus, the server 102, in some examples, may analyze data from the server 132 after a duration, the duration being an amount of time, server use, etc. In other examples, information from the server 132 may be received by the server 102 continuously. As such, the server 102 may be continuously analyzing data gathered from server 132. In still further examples, the server 102 may analyze data from the server 132 in response to a request from a user via the user device 122.

The server 102 may therefore analyze information about an event and/or a transaction from server 132 and store the analyzed information in non-transitory memory. Thus, server 102 may contain information regarding the geographic location, monetary amount, time and date, and companies involved for a plurality of transactions or linked to a customized alert. In some examples, the information stored in server 102 may comprise all current published financial data. As such, the server 102 may contain all current available data regarding any transactions taking place between two or more companies and/or state owned enterprises. Server 102 may analyze and sort the data so that it may be presented in the form of one or more of a geographic map, list, and table to a user via user device 122.

In still further examples, the server 102 may analyze the information for an activity or transaction received from the remote server 132 to determine the companies and/or state owned enterprises involved in the transaction and/or activity. The server 102 may then pull company histories, activity records, transactions records, etc., for the companies involved in the transaction and/or activity from the remote server 134. The information pulled from the remote server 134 may additionally include the risk level for each company involved in the transaction and/or activity received from remote server 132.

Thus, the server 134 may store the activity records, transaction records, and risk levels for individual companies. The information stored in the server 134 may then be pulled for companies that are involved in a new transaction, where the new transaction is a transaction received from the new transaction information from server 132.

The server 102 may determine a second risk level for the transaction and/or activity based on the company activity history, transaction history, etc., pulled from server 134 for the companies involved in the transaction and/or activity. Further, the server 102 may determine a risk factor for the transaction and/or activity based on the first and second risk levels. Thus, the risk factor for a transaction and/or activity may be accessed based on the user preferences, transaction information, and company history records for the companies involved in the transaction and/or activity. In this way, a risk level of a transaction and/or activity may be adjusted based on user defined preferences, and a company's activity and/or transactional records.

Further, the server 102 may update the risk level assigned to a company based on the new transaction and/or activity information received from the remote server 132. For example, the risk level of a company can be increased in response to the company being involved in a new transaction that has a high risk level. The server 134 may then be updated by server 102 to reflect the new company activity and/or transaction involvement, and the updated company risk level. In this way, remote server 134 may hold an active activity/transaction record for companies based on information received from the remote server 134 via server 102.

In some examples, the server 102 may estimate a risk level for each of the companies included in the company information stored on server 134. Thus, estimating the risk level for a company may be performed independently of new transaction information. For example, the server 102 may periodically, continually, or at regular time intervals, update the risk level for one or more of the companies included in the company information on server 134 based on the transaction and/or activity history for each of the companies. In other examples, the risk level may be updated based on newly identified affiliate companies, and the risk levels associated with said affiliate companies.

In this way, server 102 may receive new transaction information involving a company, may then update and adjust the risk level assigned to the company based on the new transaction information, and may then store the updated risk level in the server 134. In this way, server 134 may hold current risk levels for a plurality of companies, where the risk level may be estimated based on a transaction and/or activity history of the company.

In further examples, the server 102 may generate a notification or alert when the risk factor for a transaction and/or activity is greater than a threshold risk. The notification may be based on the perceived threat, risk, and/or significance of a transaction to a user. The perceived threat, risk, and/or significance of a transaction may be determined based on the preferences input by the user via the user device 122, inputs from an administrator via the administrator device 142, and risk exposure of a company and/or state owned enterprise involved in the transaction and/or event. For example, the risk exposure may include government-imposed sanctions on individuals, companies, and countries, corruption, etc. As such, the computing environment 100 may retrieve information regarding transactions and/or events from one or more databases and manipulate and evaluate the data together with the information obtained about the user, to determine a user personalized notification for a transaction.

By calculating and storing a risk level for a company based on the transaction and/or activity history of the company, an amount of processing power required to calculate the risk level for a new transaction involving the company may be reduced. Thus, the speed and efficiency of calculating a risk level for a new transaction may be increased by estimating and storing a risk level for the companies involved in the transaction prior to receiving the new transaction. Thus, because the server 102 may estimate and calculate a risk level for a company based on the activity history of the company, when calculating the risk factor for a given transaction, which may be based both on the risk levels for the companies involved in the transaction, and the user preferences, processing power and an amount of time to perform the calculation of the risk factor may be reduced relative to approaches where the risk level of the company and the risk factor are calculated concurrently. Thus, hardware and electrical components of the server 102 may be reduced.

Thus, a server, in communication with one or more remote servers, each having one or more databases, may collect information regarding events and/or transactions involving one or more companies and/or state owned enterprises. The server may contain one or more engines with micro-chip processors for analyzing the data received from the one or more databases. In some examples, the server may comprise a test evaluator engine for generating a user personalized risk level for an event and/or a transaction. In other examples, the server may analyze and store data related to events and/or transactions involving one or more companies, so that upon a user request from a user device, information regarding company activity may be presented to the user via a user interface.

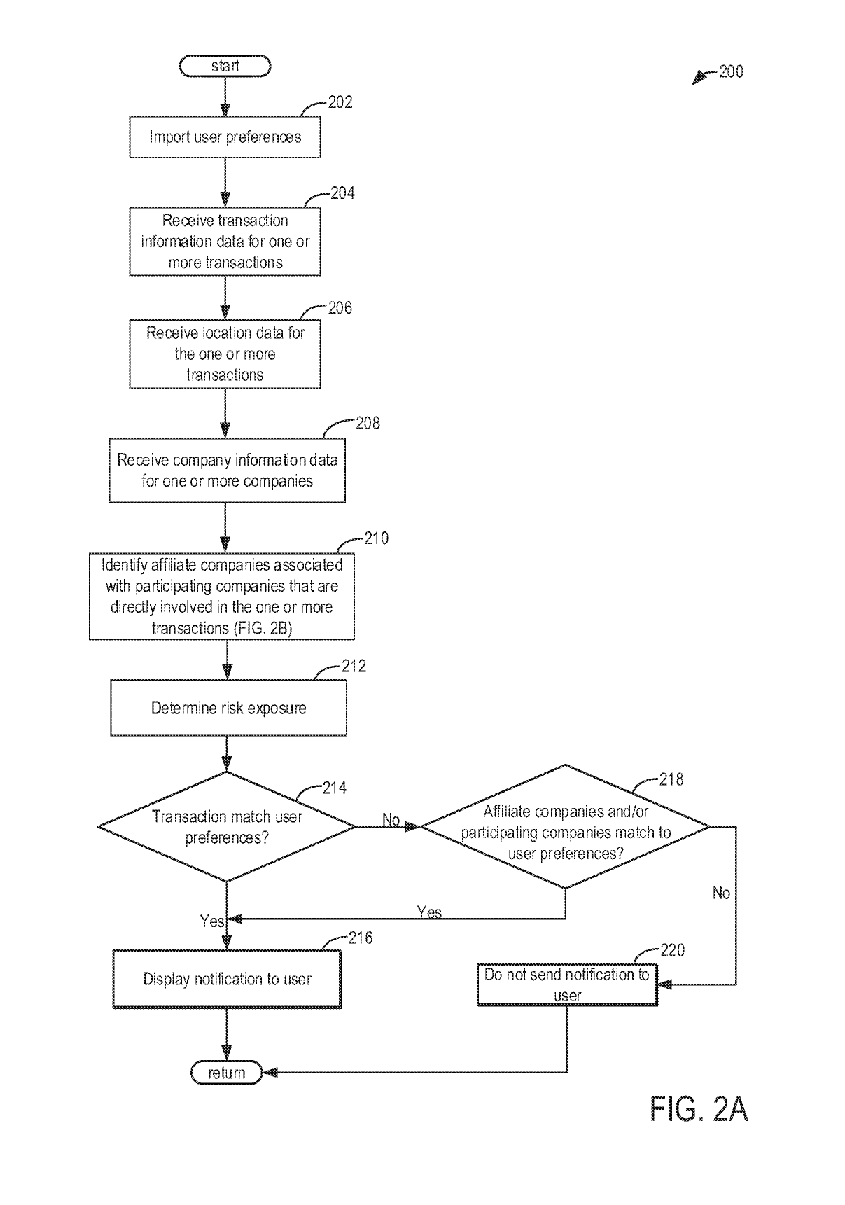

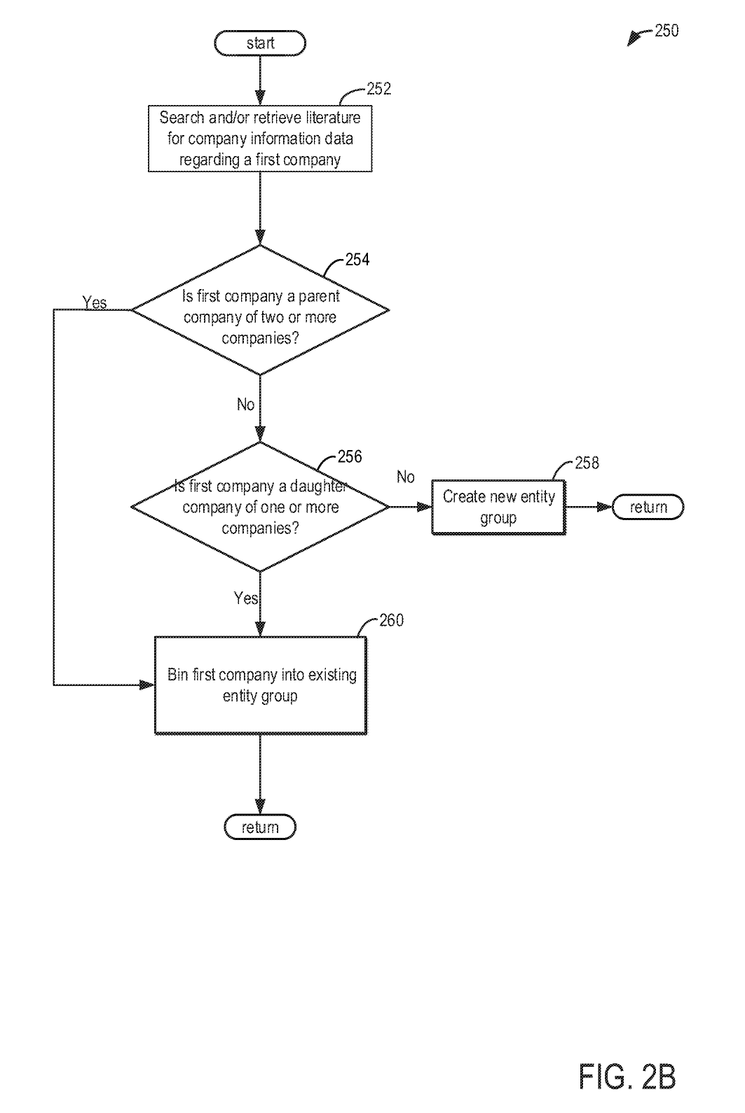

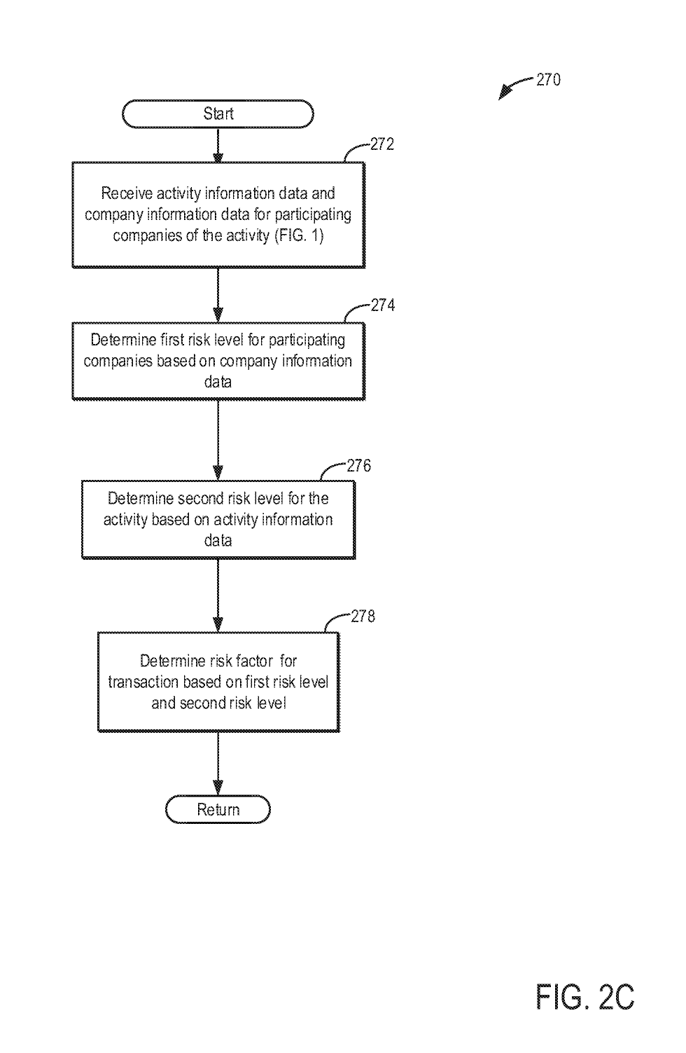

FIGS. 2A-4 show several methods for evaluating and analyzing the activity of companies and/or state owned enterprises. The method described in FIGS. 2A-4 may be executed by a computer and/or server with a logic system capable of executing computer readable instructions such as server 102 described above with reference to FIG. 1. Thus, in one embodiment, the methods described below in FIGS. 2-4 may be executed by the server (e.g., server 102 from FIG. 1), the server being part of a wirelessly connected computing environment (e.g., computing environment 100 from FIG. 1).

In some examples, the methods may also optionally include searching one or more databases of economic and political information (e.g., databases 133 from FIG. 1) for activities involving one or more companies and/or state owned enterprises.

In one example the activities may be transactions, including an exchange of currency between one or more companies and/or state owned enterprises. In other examples, the methods may include searching one or more databases based on input by a user via a user device (e.g., user device 122 from FIG. 1). Thus, one or more of the methods in FIGS. 2A-4 may be employed in response to a request from a user via the user device to search for specific transactions, companies, persons, and/or locations. Further, the methods in FIGS. 2A-4 may be used to evaluate potential risks, and threats to a user of company activity.

FIG. 2A shows a method for notifying a user of transactions that may be a significant risk to a user, and/or transactions involving user flagged companies. Further, the risk level of a transaction may be determined using, for example, the method described in FIG. 2C. FIG. 2B shows a method for identifying company and/or state owned enterprise networks. Said another way, the method described in FIG. 2B may provide a means for identifying financial associations between companies. Thus, the server may receive information from the one or more databases about a plurality of companies and/or state owned enterprises. Additionally, the server may store information regarding a plurality of companies and/or state owned enterprises from information previously received from the one or more databases. However, many of the companies may be financially linked to one another, such that funds and/or currency are transferred between the companies. In other embodiments, the companies and/or state owned enterprises may own a portion or all of another company, or a person may be employed by more than one company at once. Thus, the method described in FIG. 2B, provides a means for determining if two or more companies and/or state owned enterprises are collaborating at any level with one another. As such, the server may perform a method (e.g., method 250 described in FIG. 2B) upon receiving information regarding a company and/or state owned enterprise. The server may then store information regarding associations between companies and/or state owned enterprises so that upon a user request for information regarding a first company, the server may present the user with information regarding the first company, and all companies and/or state owned enterprises associated with the first company. Said another way, associated companies may be electronically tagged to one another, so that upon retrieval of any information regarding a first company, all other companies the first company is associated with and their corresponding information may also be retrieved. Information regarding the user search may be presented to the user by way of the method described in FIGS. 3-4.

Turning now to FIG. 2A, it shows a flow chart of an example method 200 for generating and displaying a notification to user. Specifically, the notification may be generated based on the determined risk exposure of a transaction, and/or user preferences, where the user preferences may include one or more companies of interest to a user. For example, a user may input one or more companies of interest on a user device (e.g., user device 122 from FIG. 1). The companies of interest may be stored as user preferences on a server (e.g., server 102 from FIG. 1). Upon retrieval of new transaction information data regarding one or more transactions, the server may calculate the risk exposure for the one or more transactions, and also determine any of the participating companies involved in the one or more transactions are also companies of interest as defined by the user. If the risk exposure of a transaction matches criteria established by the user in the user preferences, and/or one or more of the participating companies involved in the transaction match one or more of the companies of interest, then a notification may be generated and displayed to the user.

Instructions for carrying out method 200 may be stored in the memory of a computer and/or server (e.g., data holding subsystem 104 of server 102 from FIG. 1). As such, method 200 may be carried out by a logic system (e.g., logic subsystem 103 from FIG. 1) of the computer and/or server.

Method 200 begins at 202 which comprises importing user preferences. The user preferences may include one or more companies of interest. The companies of interest may be user selected companies. Thus, a user may select via a display, such as display 2600 shown below with reference to FIG. 9D, one or more companies of interest for which any activity involving the one or more companies of interest is transmitted to the user via a notification. The user preferences may be input by the user via the user device. Further the user preference may be stored in the memory of the server and/or computer. As such, the importing of the user preferences may include retrieving the user preferences from the memory of the server and/or computer.

After importing the user preference at 202, method 200 continues to 204 which comprises receiving transaction information data for one or more transactions. The transaction information data may be received from one or more remote server databases (e.g., databases 133 shown in FIG. 1). The remote server databases may include financial data, transaction information data, location data, company information data, etc., compiled from one or more of news, bank data, press releases, website disclosures, SEC files, or other sources of publicly reported literature. The transaction information data may include information relating to one or more transactions. As such, the transaction information data may include the name, location, time, industry, monetary amount, and type of the transaction. Additionally, the transaction information data may include the participating companies involved in the transaction. Thus, the participating companies may include one or more companies directly involved in a transaction.

After receiving the transaction information data at 204, method 200 proceeds to 206 which comprises receiving location data for the one or more transactions. The location data may include the geographic coordinates corresponding to the location which the transaction took place.

Then, method 200 may proceed to 208 which comprises receiving company information data for the one or more participating companies, and a plurality of companies not participating in the transaction. In some examples, the method 200 at 208 may comprise receiving company information data for all publicly disclosed companies. The company information data may include information about the one or more companies such as their: transaction history, management, total revenues, ownership type, country of domicile, etc.

Method 200 may then proceed to 210 which comprises identifying one or more affiliate companies associated with the participating companies that are directly involved in the one or more transactions based on the received company information data. Affiliate companies are companies that are cooperating with one or more of the participating companies. In some examples, the cooperation may be defined by legally binding contracts. Thus, in some examples, affiliate companies may be companies that are involved in one or more mergers, acquisitions, partnerships, or other type of legally binding contract with one or more of the participating companies. However, in other examples, the affiliate companies may not necessarily be involved in legally binding contracts with one or more of the participating companies, but may share more than a threshold number of characteristics with the participating companies. The characteristics may be included in the company information data. The company information data may include information about the affiliate companies and participating companies such as their: transaction history, management, total revenues, ownership type, country of domicile, etc.

Identifying the one or more affiliate companies may include determining if the participating companies are legally affiliated with the one or more affiliate companies. Thus, at 210, method 200 comprises identifying companies that are legally associated with the participating companies. Legal associations between the companies may be determined based on legally binding contracts such as mergers, partnerships, joint ventures, acquisitions, etc. Thus, the method 200 at 210 comprises identifying companies that are associated with the participating companies through published legal documents which detail a contract binding the two or more companies to one another. However, in other examples, as explained in greater detail below with reference to FIG. 2B, the method 200 at 210 may additionally include identifying the affiliate companies based on whether the participating companies share more than a threshold number of characteristics with the affiliate companies. Thus, in some examples, companies may be identified as affiliate companies of the participating companies based not only on published legal documents, but also on company information data. In some example embodiments therefore, a company may be determined to be an affiliate company of a participating company even if it is not legally bound to the participating company, but shares more than a threshold number of company information data points in common with the participating company.

However, it is important to note that in some examples, method 200 may proceed from 208 to 212, and thus in some examples, method 200 may not include identifying affiliate companies.

After receiving the company information data at 208, and/or identifying the affiliate companies at 210, method 200 may then continue to 212 which comprises determining a risk exposure for each of the one or more transactions. As described in greater detail below with reference to FIG. 2C, the risk exposure may be determined based on the transaction information data. However in some examples as shown below with reference to FIG. 2C, the risk exposure may additionally be based on the company information data, which may include records of company involvement in sanctioned activity or ties to sanctioned countries, corruption, cyber-crime, associations with sanctioned individuals, etc. Thus, the risk exposure of a transaction may be determined based on both the activity and behavior of one or more of the participating companies directly involved in the transaction, and/or the affiliate companies of the participating companies. In such examples, where both the transaction information data and the company information data are used to determine the risk exposure, the method 200 may additionally include determining a risk factor as described below with reference to FIG. 2C. Thus, in certain examples, determining the risk exposure may include determining a risk factor. As such, the method 200 at 212, in some optional embodiments, may execute the method described in 2C, to determine a risk factor for a transaction and/or event involving one or more companies.

Since the affiliate companies may be influencing the behavior of the participating companies, in some examples, the affiliate companies may be indirectly involved in the transaction, and therefore their company information data may also be used to determine the risk exposure of a transaction.

Method 200 may then continue from 212 to 214 which comprises determining if the risk exposure matches the criteria established by the user in the user preferences. The exposure may represent a threshold of risk exposure that is deemed worthy of notification by the user. Thus, if the one or more transactions, match the criteria of risk exposure set by the user, then method 200 continues to 216 which would trigger a notification to the user. The display or transactions matching the risk exposure established by the user may be displayed to the user via the user device and/or a notification may be sent to the user in the form of one or more of an email, text message, or other wireless form of communication. Thus, the risk exposure may include transaction information data points that match to user preferences input by a user. As described above, the user preferences may include geographic locations, state owned enterprises, companies, persons, types of transactions, etc. Thus, a risk exposure may in some examples be any transaction information data points of the transaction information for a given transaction that match to any of the user preferences. As such, the method 200 at 214 may include determining that the risk exposure matches to the user preferences, if any of the transaction information regarding data the one or more transactions matches to any of the user preferences. As an example, if a user preference includes the company Rosatom, and Rosatom is determined to be a participating company in the transaction, then the risk exposure may be determined at 214 to match to the user preferences.

Returning to 214, if it is determined that the risk exposure does not match the criteria established by the user, then method 200 continues to 218 which comprises determining if the one or more affiliate companies and/or participating companies match any other of the user preferences. Thus, the method 200 at 218 may comprise determining if a threshold number of the affiliate companies and/or participating companies are the same as one or more of the companies of interest stored in the user preferences. In some examples the threshold number may be one. As such, in some examples, if at least one of the participating companies directly involved in a transaction or at least one of the affiliate companies is the same as one of the one or more companies in the user preferences, then method 200 may proceed to 216 and display a notification to the user. In other examples, the threshold number may be greater than one. If less than the threshold number of affiliate and or participating companies (e.g., zero) are the same as one of the companies of interest in the user preferences, then method 200 proceeds to 220 which comprises not sending a notification to the user. Method 200 then returns.

In examples, where method 200 additionally executes the method described in FIG. 2C at 212, method 200 at 214 which may comprise determining if the risk factor is greater than a threshold. The threshold may be representing a threshold amount or risk and/or interest to the user, above which may be deemed worthy of notifying the user. Thus, if the one or more transactions, pose more than the threshold amount of risk to user, then method 200 continues to 216 which comprises displaying a notification to the user. The notification may be displayed to the user via the user device. In some examples the notification may be sent to the user. However, in other examples, the display may be sent to the user in the form of one or more of an email, text message, or other wireless form of communication. Further the notification may be presented on a user interface to the user such as the interface shown below with reference to FIG. 9A-9B. After displaying the notification to the user, method 200 then returns.

Similarly, if in examples, where method 200 additionally executes the method described in FIG. 2C at 212, method 200 if at 214, if it is determined that the risk factor is not greater than the threshold, then method 200 continues to 218 which comprises determining if the one or more affiliate companies and/or participating companies match to any of the companies of interest in the user preferences. Thus, the method 200 at 218 may comprise determining if a threshold number of the affiliate companies and/or participating companies are the same as one or more of the companies of interest stored in the user preferences. In some examples the threshold number may be one. As such, in some examples, if at least one of the participating companies is directly involved in a transaction, or at least one of the affiliate companies is the same as one of the one or more companies in the user preferences, then method 200 may proceed to 216 and display a notification to the user. In other examples, the threshold number may be greater than one. If less than the threshold number of affiliate and or participating companies (e.g., zero) are the same as one of the companies of interest in the user preferences, then method 200 proceeds to 220 which comprises not sending a notification to the user. Method 200 then returns.

Turning now to FIG. 2B, it shows a flow chart of an example method 250 for identifying company and/or state owned enterprise networks and the companies and/or SOEs that comprise them as described above with reference to block 210 of method 200 in FIG. 2A. As such, method 250 may be run as a part of method 200. Thus, method 250 may be executed at block 210 of method 200 shown in FIG. 2A. Specifically, method 250 may comprise determining based on company ownership data if one or more companies are collaborating with one another to advance the economic and or political agendas of said companies. Ownership data may be derived from company website disclosures, press releases, SEC files or other publicly available databases concerning transactions, trades, and/or acquisitions.

However, in other examples embodiments, method 250 may additionally include determining based on company financial data which may include transaction information data, financial data, if one or more companies are collaborating with one another to advance the economic and or political agendas of said companies. The financial data may be derived from company website disclosures, press releases, SEC files or other publicly available databases concerning transactions, trades, and/or acquisitions.

In other words, method 250 may involve determining associations between companies so that the activities of a first company may be correlated to the activities of one or more of second companies. It is important to note that method 250 may be executed in response to a request from a user. For example, a user may input a search for one or more companies on a user device (e.g., user device 122 from FIG. 1). In response to the request from the user, a server (e.g., server 102 from FIG. 1) in communication with the user device via a network (e.g., network 113) may execute method 250. In other examples, method 250 may be executed without input from a user. Thus, the server may execute method 250 without first communicating with the user device. As such, server may execute method 250 as part of an update as described above with reference to FIG. 1. Specifically, the server may periodically or continuously receive information from one or more remote servers (e.g., remote server 132 shown in FIG. 1), and may execute method 250 as part of an analysis of the incoming received information. Further, information analyzed during the execution of method 250 may be stored in non-transitory memory (e.g., data-holding subsystem 104 shown in FIG. 1) of the server. Additionally, new information received by the server from the one or more remote servers may be compared to information stored in the non-transitory memory of the server in the method 250.

Instructions for carrying out method 250 may be stored in the memory of a computer and/or server (e.g., data holding subsystem 104 of server 102 from FIG. 1). As such, method 250 may be carried out by a logic system (e.g., logic subsystem 103 from FIG. 1) of the computer and/or server.

Method 250 begins at 252 by searching and/or retrieving literature regarding a first company. In one example, the method 250 at 252 may involve searching all published literature for all companies and/or state owned enterprises. In other examples, the method 250 at 252 may involve searching all published literature for a company and/or state owned enterprise. In other examples, the method 250 at 252 may only involve searching literature for a company and/or state owned enterprise within a threshold amount of time from the current time (e.g., within the last one year, 5 years, 3 months, etc.). The literature may be drawn from one or more data-holding systems databases (e.g., databases 133 from FIG. 1). The literature may include news, press releases, corporate website disclosures, SEC filings, bank records, transaction records. It is important to note that method 250 may repeat itself multiple times. In other examples it may run continuously. As such the searching for literature may comprise only searching for literature published within a time period, the time period dictated by the time since the most recent iteration of method 250. As such, the method 250 at 252 may only search for literature published since the most recent execution of method 250 for the given company and/or state owned enterprise.

Continuing to 254, the method 250 may involve determining if the first company is a parent company of two or more identified companies. The identified companies may include one or more companies where information regarding those companies is stored on the server. Thus, the method at 254 may involve comparing the first company to a list of previously identified companies, where the list of previously identified companies is stored in the non-transitory memory of the server. In a first example, the first company may be a parent company of one or more identified companies if the one or more identified companies are legally represented as subsidiaries of the first company, (e.g., if they are owned and/or operated by the first company).

However, in other optional examples the method at 254 may also include determining that the first company may be a parent company of two or more identified companies if the two or more identified companies are not legally owned by the parent company, but share more than a threshold number of common characteristics with the parent company. These common characteristics may include one or more of shareholders, employees, executives, ownership, political interests, economic interests, transaction, industries, etc., that are shared in both the daughter and parent companies

Thus, in some examples, in addition to determining company associations by their legal contracts, the first company may be determined to be a parent company of two or more identified companies if more than a threshold number of common characteristics exist. As such, the method 250 at 254 may additionally or alternatively comprise generating a flag if the first company shares a common characteristic with two or more identified companies. For example, if the majority shareholders in the first company are also shareholders in two or more identified companies, a flag may be generated. If more than a threshold number of flags are generated between the first company and two or more identified companies, then the first company may be determined to be a parent company of the two or more identified companies.

In another example, the first company may be determined to be a parent company of two or more daughter companies if more than a threshold number of instances of a common characteristic exist. For example, if it is determined at 254 that more than a threshold number of executives in the first company are also executives in two or more of the daughter companies, then it may be determined that the first company is a parent company of the two or more daughter companies.

In another example, the flags that may be generated may receive a weighted score based on the number of instances of a common characteristic that exist between the first company and two or more identified companies. For example, if a flag is generated because executives in a first company are also executives, employees or shareholders in two or more identified companies, the score of the flag may increase with increasing number of shared executives. A total weighted score may be a total of the score of all flags generated for all shared common characteristics between the first company and two or more identified companies. Thus, in such examples, if the total weighted score is more than a threshold, then it may be determined at 254 that the company is a parent company of two or more identified companies.

If it is determined at 254 that the first company is a parent company of two or more identified companies, then the method 250 continues to 260, which comprises binning the first company into an existing entity group. The existing entity group may be a network, where the companies in the entity group or network have been identified as being associated with one another. Thus, a parent company and all of its associated companies may be assigned to an entity group which represents a network of collaborating companies. The binning therefore, may involve linking all of the companies in an entity group together, such that any transactions involving one or more of the companies in that entity group will also be bound to the parent company of the group. In this way, transactions assigned to a parent company may include all of the transactions involving the companies in the same entity group as the parent company. Therefore, all identified companies may be binned into entity groups based on their associations and affiliations with one another. Companies that collaborate with one another and have been identified as being associated with one another in a corporate network may be binned into the same entity group, so that the actions of one company in the entity group may be tied to the one or more of the other companies in that same entity group.

Returning to 254, if it is determined that the first company is not a parent company of one or more identified companies, then method 250 continues to 256, which comprises determining if the first company is a daughter company of an identified parent company. The identified parent company may include one or more companies where information regarding those companies is stored on the server. Thus, the method at 254 may involve comparing the first company to a list of one or more previously identified parent companies, where the list of parent companies is stored in the non-transitory memory of the server. A company may be an identified parent company if it has been determined to be a parent company of two or more companies in the manner described at 254 of method 250. Said another way, a company may be an identified parent company if in a previous iteration of method 250, the company was determined to be a parent company of two or more previously identified companies.

The determining of whether or not the first company is a daughter company of an identified parent company may include comparing the first company to a list of previously identified parent companies, where the list of identified parent companies is stored in the non-transitory memory of the server. In a first example, the first company may be a daughter company of an identified parent company if the first company is legally represented as a subsidiary of the identified parent company, (e.g., if the first company is owned and/or operated by the identified parent company).

However, in other optional example embodiments, the method 250 at 256 may additionally comprise determining if the first company may be a daughter company of an identified parent company if the first company is not legally owned by the identified parent company, but shares more than a threshold number of common characteristics with the identified parent company. These common characteristics may include one or more of shareholders, employees, executives, ownership, political interests, economic interests, transaction, industries, etc., that are shared in both the daughter and parent companies

Thus, in some optional examples, the method 250 may include determining a first company to be a daughter company of an identified parent company if more than a threshold number of common characteristics exist. As such, the method 250 at 256 may additionally or alternatively comprise generating a flag if the first company shares a common characteristic with an identified parent company. For example, if the majority shareholders in the first company are also shareholders in an identified parent company, a flag may be generated. If more than a threshold number of flags are generated between the first company and an identified company, then the first company may be determined to be a daughter company of the identified parent company.

In another example, the first company may be determined to be a daughter company of an identified parent company if more than a threshold number of instances of a common characteristic exist. For example, if it is determined at 256 that more than a threshold number of executives in the first company are also executives in an identified parent company, then it may be determined that the first company is a daughter company of the identified parent company.

In another example, the flags that may be generated may receive a weighted score based on the number of instances of a common characteristic that exist between the first company and identified parent company. For example, if a flag is generated because executives in a first company are also executives, employees or shareholders in an identified parent company, the score of the flag may increase with increasing number of shared executives. A total weighted score may be a total of the score of all flags generated for all shared common characteristics between the first company and the identified parent company. Thus, in such examples, if the total weighted score is more than a threshold, then it may be determined at 256 that the first company is a daughter company of an identified parent company.

If it is determined at 256 that the first company is not a daughter company of one or more identified parent companies, then method 250 proceeds to 258 which comprises creating a new entity group. Thus, if the first company is neither a daughter nor parent company of any of the identified companies, then a new entity group may be created, which the first company may then be binned into. If in a later iteration of method 250, if it is determined that the first company is a parent or daughter company of a company, then those companies may be binned together into the entity group of the first company. As described above at 254 of method 250, an entity group may be a network, where the companies in the entity group or network have been identified as being associated with one another. An entity group created at 258 only comprises one company. Method 250 may then return.

Returning to 256, if it is determined that the first company is a daughter company of one or more identified parent companies, then method 250 continues to 260, which comprises binning the first company into the existing entity group for the parent company. In some examples, if the first company is a daughter company of only one identified parent company, then the daughter company may be binned into only the entity group containing the identified parent company. In other examples, if the first company is a daughter company of two or more parent companies, then the daughter company may be binned into each of the entity groups associated with the respective identified parent companies. As described above at 254, by binning the first company into an existing entity group containing an identified parent company, all transactions involving the first company may also be assigned to the identified parent company. After either binning the first company into existing entity group, or creating a new entity group for the first company, method 250 then returns.

Thus, method 250 comprises receiving information about a company, determining if the company is associated with and/or collaborating with one or more other companies, and if the company is associated with other companies, identifying the type of partnership between them. Method 250 may additionally comprise linking collaborating companies in a network to one another, so that actions from any daughter companies may be tied directly to the parent company. In this way, information provided to a user about a parent company may include all information involving the daughter companies of the parent company. As described below with reference to FIGS. 3-4, a user may request information about a company via a user interface.

Turning now to FIG. 2C, it shows an example method 270 for determining the risk factor of a transaction as described above with reference to block 212 shown in the method 200 of FIG. 2A. As such, method 270 may be run as part of a subroutine of method 200. However, in some examples, the method described in FIG. 2A, may be executed without executing the method described below in FIG. 2C. Thus, in some examples, the method described in FIG. 2C may be executed without calculating a risk factor. Instructions for carrying out method 270 may be stored in the memory of a computer and/or server (e.g., data holding subsystem 104 of server 102 from FIG. 1). As such, method 270 may be carried out by a logic system (e.g., logic subsystem 103 from FIG. 1) of the computer and/or server.

Method 270 begins at 272 which comprises receiving activity information data and company information data for one or more participating companies for an activity in the manner described above with reference to blocks 202-206 of method 200 in FIG. 2A. An activity may comprise a transaction as described above with reference to FIG. 2A. However, in other examples, an activity may additionally or alternatively comprise a meeting, press conference, political election, legal decision, land acquisition, trade, embargo, sanction, war, natural disaster, tariff, acquisition, merger, bankruptcy, etc., that may directly or indirectly involve one or more companies or state owned enterprises.

The activity information data may include for example the type of activity such as transaction, conference, merger, etc. Further, the activity information data may include a time and geographic location at which the activity occurred. In examples where the activity involved the transfer of money, material goods, commodities, etc., the monetary value of the transfer may be included in the activity information data. In still further examples, the activity information data may include the type of industry of the activity.

Participating companies may be defined as companies directly and/or indirectly involved with the activity. Thus a participating company may be a company that receives and/or pays money or other object of monetary value in the activity. For example a company that donates money to a political campaign may be considered a participating company of the political campaign. In another example, a company supplying arms for a war may be considered a participating company in the war. In yet another example, a company that sponsors a meeting, conference, rally, etc., may be considered a participating company.

In yet another example, a participating company may be identified as a company including one or more employees that are involved in the activity. For example, if a CEO of a company is a keynote speaker at a conference, that company may be identified as a participating company of the conference. In yet further examples, participating companies may be affiliate companies of companies involved in the activity.

The company information may include an activity history of the company which may include a list of transaction that the company has participated in and/or activities that the company has participated in (e.g., mergers, acquisitions, conferences, etc.). Thus, a record of transactions that a company has participated in may be stored in non-transitory memory of one or more remote servers (e.g., remote server 132). Further, the company information may include a list of employees, executives, gross yearly profit, country of domicile, etc.

After receiving the activity information data, and company information data at 272, method 200 then continues to 274, which comprises determining a first risk level for the activity and/or transaction based on the company information data for the one or more participating companies and/or affiliate companies. The first risk level may increase for increases in the risk exposure of the activities in which the company has participated. Further, the first risk level may additionally or alternatively increase for increases in the number of activities (e.g., transactions) which match the user preferences. In yet further examples, the first risk level may be estimated based on imposed government sanctions, involvement in criminal activity, corrupt business practices, persons involved with the company that are subject to sanctions, business ties to countries that are subject to sanctions or other risk factors, exposure to cyber-crime allegations, exposure to corruption allegations, etc.

After determining the first level at 274, method 270 may then proceed to 276 which comprises determining a second risk level for the activity based on the activity information data. For example, the second risk level may be based on whether the activity is taking place in high risk countries, involves sanctionable or other high risk activity, involves economic sectors that are higher risk (e.g., defense, high-tech, nuclear, et. al.), involves monetary amounts that are unusual or unexpected, etc. Thus, the first risk level may be adjusted based on the location, type, amount, etc., of the transaction. In some examples, the first risk level may be adjusted based on user preferences. For example, a user may adjust the risk level of transactions in a country of geographic region. Thus, for a transaction occurring in a region or country assigned a higher risk level by a user, the transaction may be assigned a higher risk level than a transaction occurring in a region or country assigned a lower risk level by the user.

After determining the second risk level, method 270 may proceed to 278 which may comprise determining a risk factor for each of the one or more activities based on the first risk level and the second risk level. In one example, the risk factor may be determined by weighing equally the first risk level and second risk level. As such, the risk factor may increase with increasing levels of the first risk level and second risk level. In another example, the risk factor may be determined by weighing the first risk level more than the second risk level. In such examples, increases in the first risk level may result in greater increases in the risk factor than increases in the second risk level. As such, the activity of the one or more of the transaction information data points may be weighed more heavily than the activity of the transaction's participating companies when determining the risk factor. After determining the risk factor at 278, method 270 then returns.

However, in other examples, the method at 278 may additionally or alternatively comprise determining the risk factor based on the transaction history of one or more of the companies involved in the transaction, the country in which the transaction took place, type of industry of the transaction, etc. Thus, in some examples, the method at 278 may include comparing the transaction information data of the transaction with a record of transaction information. For example, if the transaction occurred in China, a record of transactions having taken place in China may be generated and compared with the current transaction. In other examples, more than one piece of transaction information data may be used in the comparison. For example, if the transaction occurred in China, and involved the company Rosatom, then a history of all transactions involving Rosatom and conducted in China may be generated and compared to the current transaction.

Further, in some examples, the method at 278 may additionally include generating a regression model, or other statistical analysis techniques for determining trends in transaction activity, company profiles and company behavior, for the generated history of transactions. In some examples, the regression model may be a linear regression model. However, in other examples, the regression model may be a non-linear regression model. As an example, a regression model may be generated for all transactions involving Rosatom conducted in China. Thus, regression models may be created for transactions, where each regression model may be created based on one or more data points of the transaction information data and/or company transaction information data. As such, regression models may be created for any combination of the companies involved in a transaction, date of the transaction, country in which the transaction took place, type or industry of the transaction, etc. Said another way, the model parameters used in the regression models may include data in one or more of the transaction information data, and company information data, which may include the companies involved in a transaction, date of the transaction, country in which the transaction took place, type or industry of the transaction, monetary amount of the transaction, etc.

Further, a risk factor for a given company or group of affiliated companies may be generated based on the transaction history of the company and/or group of affiliated companies. Thus, the risk factor for a given company may be adjusted based on the activity of the company and/or its affiliated companies. For example, if a company becomes more involved in illegal activities, continues to pursue transactions in a geographic region that the user has identified as a high risk region, is involved in types of transactions that are flagged by the user, etc., then the risk factor for that company may be increased. A user may be notified more frequently of transactions and/or activity involving companies with higher risk factors. Thus, as a company becomes more involved in transactions and/or activity that pose more of a risk to a user, the user may be alerted of the company activity.

Further, this regression model applied to data points collected on historical transactions and participating companies may be used to predict company behavior, and transactions that will occur in the future. For example, if the number of oil transactions in China has been steadily increasing by two transactions each month, then the regression model may predict that around two more transactions will occur in China in the month proceeding the current month. Thus, the regression model may also be used to determine if certain aspects of a transaction are unexpected, anomalous and potentially worthy of special attention based on how it compares to the regression model, and the expected pattern of transactions. Thus, if it is predicted by the regression model that during a given month only five transactions involving Rosatom will occur in China, but ten actually occur, it may be determined that Rosatom is worthy of being highlighted to users concerning the significance of this unexpected discovery. More generally, the relevance and worthiness of a transaction or group of transactions may be determined based on the difference between the transaction information and a regression line. If the difference is greater than a certain threshold, a notification concerning the transaction, company or other data point may be generated. In some examples, this notification may be generated automatically based on a calculation of the transaction criteria and the statistical estimates produced and then displayed or transmitted to a user.

As such, transaction forecast information may be plotted based on historical data accumulated concerning one or more of a combination of the transaction information and company information data points (e.g., location, date, amount, companies involved, etc.) Regression lines, or other statistical analytics means, may be fitted to the transaction information data to generate predicted future transaction information.

Turning now to FIG. 3, it shows an example method for displaying information regarding transactions involving one or more companies to a user via a user device (e.g., user device 122 shown in FIG. 1). A user may request information relating to one or more of transactions, offices, actions, etc., involving one or more companies. In response to the user request, a user interface (such as display 500 shown below in FIG. 5) may be presented to the user displaying the requested information. For example, a user may input a search for one or more companies on the user device. In response to the request from the user, a server (e.g., server 102 from FIG. 1) in communication with the user device via a network (e.g., network 113) may execute method 300. Information pertaining to the user request may be stored on one or more of non-transitory memory of the server (e.g., data-holding subsystem 104 shown in FIG. 1), and databases (e.g., databases 133) of one or more remote servers (e.g., remote server 132).

In some examples, only information stored on the non-transitory memory may be displayed to the user. However in other examples, the server may communicate with the remote server via a network (e.g., network 117 shown in FIG. 1), and information from both the remote server and the non-transitory memory may be displayed to the user. The information may include data relating to transactions and office locations of one or more companies. Further the data relating to the transaction may include the date, time, amount, location, and parties involved in the transaction. Instructions for carrying out method 300 may be stored in the memory of a computer and/or server (e.g., data holding subsystem 104 of server 102 from FIG. 1). As such, method 300 may be carried out by a logic system (e.g., logic subsystem 103 from FIG. 1) of the computer and/or server.

Method 300 begins at 302 which comprises receiving user input. The user input may be a request from a user via the user device. The user input may include a search request for one or more companies, transactions, locations, time intervals, etc. After receiving the user input at 302, method 300 continues to 304 which comprises searching the non-transitory memory based on the user input. In other examples, the method 300 at 304 may additionally or alternatively include searching the databases of the one or more remote servers based on the user input. As such, the method 300 at 304 may include parsing through data stored in one or more of the non-transitory memory and databases. After searching through the non-transitory memory at 304, method 300 proceeds to 306 and determines if a data point is related to the user search.

Thus, for each data point in the one or more non-transitory memory and databases, it may be determined at 306 whether or not that data point is related to the user search. Said another way, the method 300 at 306 may involve determining if a data point matches to the user search. Other means of matching a data points to the user search may include indexing, or other matching algorithms. The data point may represent a stored entry or data value which may correspond to a company, transaction, location, date, etc.

If at 306 it is determined that the data point is not related to the user search, then method 300 continues to 308, and excludes the data point. However, if it is determined at 306 that the data point is related to the user search at 306, then method 300 continues to 309 which comprises returning the data point. Therefore, the data point may not be excluded and may be held in the memory of the computer and/or server. After returning the data point at 309, method 300 continues to 310 which comprises determining if the search is complete. Determining if the search is complete may comprise determining if all of the non-transitory memory and/or databases have been parsed through. Thus, it may be determined that the search is complete if all of the data stored in one or more of the non-transitory memory and databases has been parsed through. If the search is not complete at 310, then method 300 returns to 304 and the non-transitory memory continues to be searched based on the user input.

Once all of the data in the non-transitory memory and or databases has been searched, and all of the data points related to the user search have been returned, method 300 continues from 310 to 312, which comprises gathering the data points associated with the returned data points. For example, if one of the returned data points relates to a transaction, the associated data points may comprise information relating to the amount, location, and parties involved in the transaction. The method 300 at 312 may additionally involve gathering all data points relating to companies involved in the returned data points as described above in the method shown in FIG. 2B. For example, if the user input is a search request for a transaction, not only may data points corresponding to the companies involved in the transaction be returned to the user, but additionally, data points relating to companies associated with the companies involved in the transaction may also be gathered. Thus, for a given transaction, data relating to the companies involved in the transaction, and their associated companies comprising a corporate network may be gathered. Thus, method 250 shown in FIG. 2B may be executed as a subroutine of method 300 at 312.

After gathering the data points at 312, method 300 continues to 314, which comprises presenting a geographic map to a user with transactions and/or office locations related to the user input. Specifically, the method 300 at 314, may involve displaying a geographic map to a user via the user device. Then, the geographic map may be populated with the gathered data points related to the user input. Thus, the data points corresponding to the location of each transaction and/or office location may be used to match each transaction and/or office to a specific point on the geographic map. Each transaction and/or office location may be distinguished by a marker. The marker may be a graphic or symbol, such as a pin, depicting a specific point on the geographic map. As such, the user may be able to see the location of all transactions, and/or company office locations related to their input as shown below with reference to the user interfaces presented in FIGS. 5A-5H.

In a further example, the method 300 at 314 may comprise generating a transaction timeline for a company and/or network of affiliated companies. Thus, the method 300 at 314 may comprise generating a graph or chart depicting the transaction history of a company or group of affiliated companies over a threshold duration. Method 300 then returns.

Turning now to FIG. 4, it shows an example method 400, for displaying a geographic map to a user with transaction involving user defined companies. A user may be interested in the actions and activities of a certain company or group of companies. As such, they may desire to search for only a subset of all transactions, namely those transactions directly and/or indirectly involved in the subset of transactions. Thus, in response to a user request for a search of a single company or group of companies, a method such as method 400 may be executed. In response to the user request, a user interface (such as display 500 shown below in FIG. 5) may be presented to the user displaying the requested information. In response to the request from the user, a server (e.g., server 102 from FIG. 1) in communication with the user device via a network (e.g., network 113) may execute method 400. Information pertaining to the user request may be stored on one or more of non-transitory memory of the server (e.g., data-holding subsystem 104 shown in FIG. 1), and databases (e.g., databases 133) of one or more remote servers (e.g., remote server 132). Instructions for carrying out method 400 may be stored in the memory of a computer and/or server (e.g., data holding subsystem 104 of server 102 from FIG. 1). As such, method 400 may be carried out by a logic system (e.g., logic subsystem 103 from FIG. 1) of the computer and/or server.

Method 400 begins at 402, which comprises receiving user search input for one or more companies of interest. Thus, in some example the user may request a search for a specific company. In other examples the user may search for a group of companies. The group of companies may be determined based on one or more parameters, such as company type, country of domicile, ownership type, etc. Thus, in some examples a user may search for only Russian companies. In further examples, a user may narrow their search to only Russian oil companies. Thus, the user may define their search by one or more of the parameters for a specific group of individual company. In still further examples, a user may search for several individual companies at once. For example, a user may search for Microsoft and Apple in one search.

In response to the user search input at 402, method 400 may continue to 404 which comprises identifying one or more affiliate companies associated with the one or more companies of interest in the manner described above with reference to FIG. 2B.

After identifying the one or more affiliate companies of the one or more companies of interest included in the user search input, method 400 may then continue to 406 which comprises gathering transaction information data, location data, and company information data for the one or more companies of interest and their affiliate companies in the manner described above at step 202-206 of method 200 in FIG. 2A. Thus, the method 400 at 406 may include gathering a list of all of the transactions that the companies of interest were directly involved in, and/or their affiliate companies were directly involved in. As such a list of all the transaction that the companies of interest were either indirectly or directly involved in may be gathered at 406.

Method 200 may then proceed from 406 to 408 which comprises populating a geographic map with the transaction of the one or more companies of interest and the affiliated companies based on the transaction information data and the location data in the manner described above with reference to FIG. 2B.

After populating the geographic map, method 400 may continue to 410 which comprises displaying the geographic map to a user with the transactions depicted as markers, where the transaction may be differentiated based on user defined parameters, where each parameter is matched to a different visual marker. The user defined parameters may include the type of transaction, which of the one or more companies of interest was involved in the transaction, whether the transaction involved one of the one or more companies of interest, or one of the one or more affiliate companies, amount of the transaction, industry of transaction, location of transaction, keyword, date of transaction, etc. The visual markers may in some examples include a pin. The visual markers correspond to the actual geographical location of the transaction. The shape, size, and color of the visual marker may be changed to distinguish the markers from one another.

In some optional embodiments, the same markers may be used to match to a particular user defined parameter. For example, if a user chooses to differentiate the transactions based on which of the one or more companies of interest was involved in the transaction, the transactions involving the same company of interest may all be given a common characteristic. For example the markers for a particular company of interest may be colored red. In other examples, the transactions may be further differentiated based on whether they involved one of the companies of interest of one or their affiliates. Thus, for transactions directly involving a company of interest, the marker shape may be triangular, whereas for transaction involving an affiliate may be square shaped. Thus, the transactions may be differentiated from one another based on user defined parameters, where an associated shape, size, or color of the marker used to identify each transaction may be changed based on the user defined parameters.

In a further example, a size of the markers may be adjusted based on the amount of the transaction, and/or a number of transactions within a region. Thus, a transaction density, and/or a total value of the one or more transactions may be represented by a size of the markers, where the size of the markers may increase for increases in the value of the transactions, and/or for increases in the number of transactions or transaction density within a geographic area over a threshold duration. Method 400 then returns.

In this way, methods are provided which allow a user to track company activity, and also be notified of company activity that may pose a particular risk, threat or interest to the user. Company activity may be made more transparent by being presented to a user on a geographic map. As such the motivations and behavioral patterns of companies may be clearer. Examples of user interfaces which may be presented to a user for visualizing company activity are shown in FIGS. 5A-5H.

The user interfaces shown in FIGS. 5A-11D may be presented to a user via a user device (e.g., user device 122 shown in FIG. 1). Thus, FIGS. 5A-5H may show example interfaces displayed to a user on a display system (e.g., display subsystem 125 shown in FIG. 1), to allow a user to track company activity. As such, FIGS. 5A-11D will be discussed together.

Turning to FIG. 5A, it shows a first display 500. All of the displays in FIGS. 5A-5H are relatively the same in their structure and format. FIGS. 5B-5H, show example displays that may be presented to a user in response to a user selection of one or more tabs on the first display 500. As shown in the examples of FIG. 5A, the display 500 (and displays in FIGS. 5B-5H) may include a side bar 502 and a top bar 504. The top bar 504 may extend across the width of the display 500 at the top of the display 500. The side bar 502 may be located at one side of the display 500 and may extend from the top bar 504 to the bottom of the display. Between the top bar 504 and the side bar 502 a geographic map 506 may be presented. Overlaid on the map 506 may be a plurality of markers 508 representing transactions, events, office locations, customized alerts, etc., which involve one or more companies. The markers 508 may be in the form of a pin or other graphic. The position of the marker on the map corresponds to the location of that transaction, action, or office location. The geographic map 506 may be populated with the markers 508 using a method such as the example method described above with reference to FIG. 3.

The markers 508 may additionally be differentiated based on the type of information they represent. For example different markers may be used to distinguish transactions from office locations.

In some embodiments, different markers may optionally be used to distinguish different types of transactions (purchases, trades, stock sales, etc.). In still further examples, different markers may be used to distinguish time intervals in which transactions took place, companies, corporate networks, origin of nationality of one or more companies, dollar amount of the transactions, etc. The markers may be differentiated from one another by color, shape, size, etc.

Further, the size of the markers may be adjusted based on a dollar amount of the transactions, and/or number of transactions within a geographic region. Thus, transaction density and/or transaction value may be represented by the relative sizing of the markers 508.

A user may filter the markers 508 presented on the map 506 by selecting tabs on the side bar. The side bar may include separate tabs for transactions, office locations, and customized alerts. As such, a user may filter the markers displayed on the map by transactions, office locations and customized alerts.

Turning to FIG. 5B, it shows an example user display 600 that may be presented to a user in response to a selection of a transaction tab 510. A user may select the transaction tab 510, and be presented with a drop down menu for filtering the transaction results on the map 506. The transactions may be filtered by company name, partner and/or customers, transaction details, location, keywords, risk, and transaction date. Thus, a user can filter the transactions presented on the map 506, so that only transactions involving certain companies are shown. Further, filters can be applied so that transactions involving subsidiaries of specific companies, and/or owners of those companies are also included in the markers presented on the map. A user can further filter the results so that only transactions involving companies from specific companies of origin are shown to the user. For example as shown in FIG. 5B, a user may select “Search all Russian SOEs” so that only transactions involving Russian SOEs are presented on the display 600.

Additionally or alternatively, a user may filter the transactions displayed on the display 600 so that only transactions involving partners and/or customers of one or more companies are displayed on the map. Further, a user can filter the markers so that only transactions involving a particular industry, type of transaction, or range of dollar values is presented on the display 600. For example, a user may filter the transaction so that only transactions that are part of the telecommunications industry are displayed on the map. In other examples the user may filter the transactions so that only those transactions that are greater than $2 million are displayed on the map.

Further, as shown in FIG. 5C, a user can filter the transactions presented on a display 700, so that only transactions taking place within a certain time interval are shown. Further, a user can filter transactions, so that only those that are currently taking place, are pending, have already been completed, or are expected to take place in the future are presented on the display 700.

If a user selects an office locations tab 512, the user may be presented with a drop down menu with options to filter office locations displayed on a display, such as the example display 800 shown in FIG. 5D. As seen in the example display 800 of FIG. 5D, a user can filter the office locations presented on the display 800, so that office locations of only specific companies, their subsidiaries, and owners are displayed. The office locations of companies may be further filtered by their country of origin, address, type of company, location, persons, etc.

Turning now, to FIG. 5E, it shows an example display 900 that may be presented to a user in response to a selection of a customized alerts tab 514. Customized alerts may be generated using a method such as the method described above in FIG. 2C. The customized alerts may include transactions or events that may pose a risk, threat, and or special interest to a user. A user may filter the markers presented on the map of display 900 so that only customized alerts from a specific region, location, and/or alert date are presented on the map.

Returning to FIG. 5A, tabs on the top bar may allow a user to search for transactions events, and/or office locations involving specific countries, companies, and/or persons. Upon selection of one of the tabs on the top bar, a drop down menu may be presented to the user to select specific transactions, event, and/or office locations.

For example, as shown in the example display 1000 in FIG. 5F, a user may select a country tab 516 on the top bar 504, and then be presented with a drop down menu 518 allowing the user to search for transactions, events, and/or office locations in a specific country. Turning to FIG. 5G, it shows an example display 1100 where a user may select an entity tab 520 on the top bar 504, that allows a user to select a specific company, so that only transactions, events, and/or office locations involving that company are presented on the map shown in display 1100. Further, as shown in the example display 1200 of FIG. 5H, where a user may select a person tab 522 on the top bar 504, to select a specific person, so that only transactions, events, and/or office locations associated with that person are displayed on the map shown in display 1200.

Returning to FIG. 5A, the top bar may additionally include tabs for switching from the display 500 to other displays which present transactions, events, and/or office locations in the form of one or more graphs, charts, tables, and lists instead of on a map. For example, in response to a user selecting an analytics tab 524, a user may be presented with one or more graphs or charts summarizing the transactions, events, and/or office locations previously presented on the map in display 500.

Turning to FIG. 6A, it shows an example display 1300 that may be presented to a user in response to the user selecting the analytics tab 524. The transactions may be sorted and analyzed based on where the transaction took place, and/or the value (e.g., dollar amount) of the transaction. As such, a user can quickly identify which countries have the highest concentration of company activity, and through which countries product is flowing most rapidly.

Further, as shown in the example display 1400 of FIG. 6B, transactions may be sorted in a chart or graph 526 by their type of industry. Thus, the more active industries may be easily discerned. For example, the transactions may be sorted by the number of transactions in a particular industry. As shown in FIG. 6B, for example, energy has more transactions, and more capital being spent in those transactions than finance or telecommunications. Thus, transactions may be grouped into their associated industry, and then ranked based on the number of transactions, and the amount of capital being transferred in those transactions.

Returning to FIG. 5A, if a user selects a list tab 528 from the top bar, the user may subsequently be presented with a list of the transactions, events, and/or office locations on the map of display 500. For example, display 1500 shown in FIG. 6C, may be presented to a user in response to the user selecting the list tab 528. As seen in display 1500, a list 530 of the transactions may be presented to the user based on the user input. As such, the list format may be similar to search results from a search engine.

Returning to FIG. 5A, if a user selects a table tab 532 from the top bar, the user may be presented with a table 534 of the transactions, events, and/or office locations shown on the map of display 500. For example, display 1600 shown in FIG. 6D, may be presented to a user in response to the user selecting the list tab 532. As seen in display 1600, the table 534 showing transactions may be presented to the user based on the user input. The table 534 may include a title 536 of the transactions, type of industry 538 of the transactions, start date 540, end date 542, status 544, companies involved 546, a location 548, and a value 550. The status may include whether the transaction is active, pending, completed, or not yet started.

Returning to FIG. 5A, in other embodiments the top bar of the display 500, may additionally a tab which upon selection may allow a user to set one or more notification preferences, such as the notification preferences discussed above with reference to FIG. 2C. An example display presented to the user in response to selection of the notifications tab is shown at example display 2700 of FIG. 9D.

Turning to FIG. 9D, is shows an example display 2700 which allows a user to input notification preferences. Specifically, a user may desire to be notified of any activity involving a specific company, person, etc. As shown in FIG. 9D, a user can enable notifications via a notification tab 2602 for a particular company, transaction, geographical region, etc. In the example shown in FIG. 9D, a user is shown to have enabled notifications for Rosatom, so that any transactions involving Rosatom will immediately be communicated to the user. In other examples, a user may elect to receive notifications for transactions in a particular industry, location, within a certain range of value, etc.

Returning again to FIG. 5A, in other embodiments, the display 500 may optionally be structured, so that the analytics, list, and table tabs are located in the bottom right corner of the display 500. Additionally or alternatively, the display 500 may include an events tab. By selecting the events tab, a user can filter the transactions, events, and/or office locations presented on the map, so that only those associated with a particular type of event are displayed on the map. For example, events may be filtered so that only those events that are one or more of political, military, economic/financial, and or geopolitical are shown on the map.

A user may select one or more of the markers 508 on the map 506 in display 500, and subsequently be presented with information about that marker. Since the markers 508 may correspond to one or more of transactions, office, events, locations, customized alerts, etc., the information presented to the user when selecting a marker may depend on what the marker corresponds to. The information may be in the form of a list, where a user may select one item in the list of one or more items.

For example, display 1700 in FIG. 7A, shows information about a marker corresponding to the city, London, United Kingdom. Specifically, upon selecting the marker corresponding to London, a user may be presented with a list of all recent transactions having taken place in London. Alternatively, the list of transactions for London may be only those transactions which fall under the one or more filters a user has applied to the search. As shown in the example of FIG. 7A, a user may select one of the one or more transactions from the list of transactions for London, which may direct the user away from display 1700 and the map shown therein, to a display including information about the specific transaction the user has selected. As an example, if a user selects the transaction titled “Purchase of Credit Suisse's Headquarters” in display 1700, the user may then be redirected to display 1800 shown in FIG. 7B.

The display 1800 is therefore an example display that may be presented to a user when a user selects a specific marker on a map, such as any of the maps shown in FIGS. 5A-5H. Display 1800 shows information about the transaction “Purchase of Credit Suisse's Headquarters.” Information about the transaction such as the transaction type, companies involved in the transaction, industry of the transaction, city and/or date where the transaction took place, project value, and a description may all included in the display 1800. Additionally, a brief description of the transaction may be included.

FIG. 7C, shows an example display 1900, that may present additional information to the information included in display 1800. For example, the display 1900, may include additional information about the companies involved in the transaction shown in display 1800, such as the name of the companies, their entity type (e.g., sovereign wealth fund, corporation/bank, etc.) ownership type (e.g., state-owned enterprise, publicly traded, etc.), country of origin, and persons associated with the companies. Further, if the one or more companies involved in the transaction is associated with other companies, a list of the companies it is collaborating with, and/or its partners with, may additionally be included. Any risk exposure associated with the one or more companies may also be included in the display 1900. As shown in the example display 1900, Qatar Holding is involved in the transaction shown in display 1800. Since Qatar Holding is a state-owned enterprise, it is associated with the government of Qatar. The government of Qatar has risk exposure including to a political freedom risk as well as a press freedom risk, which may be displayed in display 1900. Further, citations may be included in the display 1900, so that a user can verify the source of the risk associated with the one or more companies, countries, persons, etc., involved in the transaction.

Further, after selecting a marker included on a map from any of FIGS. 5A-5H, and selecting a single item from a list of items corresponding to that marker, a user may select individual companies, persons, or transactions, presented on the subsequent display such as displays 1800 and 1900 from FIGS. 7B and 7C, respectively. The example display shown in FIG. 7D, shows a display 2000 that may be presented to a user in response to the user selecting Qatar Holding from either display 1800 or display 1900 in FIGS. 7B and 7C, respectively. On display 1800 a user may be presented with information about Qatar Holding such as their country of origin, entity type, ownership type, website, year founded, number of enterprises, risk exposures, office locations, persons, and transactions, etc.

Further, as shown in the example display 2100 of FIG. 7E, a user may be presented with charts and/or graphs analyzing the activity of Qatar Holding. Thus, the information included in display 2100 may be of a similar format to that shown above with reference to displays 1300 and 1400 of FIGS. 6A and 6B, respectively. For example, the display 2100 may show charts breaking down the transactions of Qatar Holding to their industry type (e.g., real estate, energy, transportation, etc.). In other examples, the transactions may be broken down by the country where they took place (e.g., United Kingdom, France, Italy, etc.).

Returning to FIG. 5A, a user may enter a search for a specific event, transaction, person, company, etc. in a search tab 560 located on the side bar 502. In response to the user search request, a user may be directed away from the geographic map 506 to a display including information about their specific search. For example, if a user searches “Qatar Holding,” then the user may be directed to the display 2000 shown in FIG. 7D, which as discussed above includes information about the company Qatar Holding. As such, a user may be directed to a display, such as display 2000 with information about a specific company, transaction, person, etc., either by inputting a search, or by selecting a specific item from a list of one or more items corresponding to a marker on the map.

In other embodiments, in response to a user search for a specific company, transaction, person, location, etc., information corresponding to a marker on the map that matches the user search may be presented to the user. An example display that may be presented to the user in response to a user search for the city Amsterdam, Netherlands, is shown in FIG. 8. Thus, display 2200, shown in FIG. 8, may be displayed to the user in response to a search for Amsterdam. Similar to the display 1700 shown in FIG. 7A, display 2200 shows a list of items including transactions and office locations in Amsterdam. A user may select one of the transactions and/or office locations shown in display 2200, and be directed to a display similar to the displays 1800 and 2000 shown in FIGS. 7B and 7D, respectively, where additional information about the item is presented to the user. Further, a user may save their searches. A user may view their saved searches on a display such as display 2600 shown in FIG. 9D.

Turning now to FIG. 9A, a display 2300 is shown, which is an example display that may be presented to a user when a customized alert is generated. A customized alert may be generated if a transaction or event is deemed to hold special relevance to the user. A map, such as the maps shown in FIGS. 5A-5H is presented to the user on display 2300. Customized alerts may be distinguished from other markers on the map, by a flag. The flag may be an icon that is flashing, blinking, or constantly changing in size, color, or appearance. Thus, the flag which corresponds to a customized alert may be different than the other markers on the map. As shown in display 2300, the flag may be a red circle that surrounds the marker corresponding to the location of the customized alert on the map. A user may select the alert presented in display 2300, and be guided to another display which presents information about the customized alert to the user, such as display 2400 shown in FIG. 9B.

The display 2400 shown in FIG. 9B may correspond to a customized alert titled “U.S. Position on the Asian Infrastructure Investment Bank Undermined by the Weight of European Participation.” Thus, display 2400 shows the name of the customized alerts, location, date(s), and description of the customized alerts. As such, a user is notified of transactions or company activity that may pose a threat, risk, or significant interest to the user. Further, the user may request for more information about the alert by selecting the flag corresponding to the customized alerts on the map.

In other examples, a user may view a list of all their customized alerts on a display such as example display 2500 shown in FIG. 9C. As shown in display 2500, a list of customized alerts may be presented to a user. Further, as described earlier, and shown in FIG. 9D, a user can adjust their customized alert settings, to manage how customized alerts are generated. Specifically, a user may adjust for which transactions, companies, persons, etc. customized alerts are generated and presented to the user.

Additionally or alternatively, a user may be provided with updates on recent company activity. These updates may be sent to a user at regular time intervals, such as daily, weekly, monthly, etc. Further the updates may be sent to the user, via a notification, email, text message, or other wireless form of communication. FIG. 10 shows an example display 2700 of an update that a user may receive. The display 2700 shows an update that may be sent to the user daily. The update shown in display 2700 includes six new transactions. The transactions shown in the update may be a list of the company activity from the time the most recent update was sent to the user. The updates may include information about company activity, such as transactions, partnerships, projects, etc.

In this way, a user interface may be presented to a user which presents company activity on a geographic map. Specifically, the company activity may be represented on the map by one or more markers. The markers may correspond to transactions, office locations, or cities where one or more companies are involved. Thus, via the user interface, company activity can be sorted and organized by geographic location, so that trends and patterns of activity of one or more companies may be more transparent to the user. Further, the user can filter the company activity, and therefore the markers on the map, to include only a subset of companies, locations, types of transactions, date ranges involving those transactions, values of the transactions, etc. As such, the user can eliminate company activity that is not of interest to the user, so that only the company activity that is of interest to the user is presented on the map.

Additionally or alternatively, the user can search for specific companies, locations, events, and or persons. By conducting a search, or by selecting one of the markers on the map, a user may be presented with supplemental information about the company, location, person, etc. In other examples, the user interface presented to the user may organize company activity into one or more graphs, charts, lists, and tables. The user may also switch between viewing company activity on the map, to viewing it on one or more of the graph, chart, list, and table. As such, the same information regarding company activity may be presented in different forms to a user (e.g., on a map, graphs, charts, lists and tables).

Further, customized alerts may be generated and presented to the user via the user interface, so that a user may immediately be notified of any actions that may pose a risk to the user. The user can also configure the customized alerts according to their personal interests, so that they are alerted of an activity involving user identified companies, persons, or types of transactions.

Turning now to FIGS. 11A-11D, they show other embodiments of displays that may be presented to a user. Specifically, the displays in FIGS. 11A-11D, present information regarding company activity to the user in the form of tables. The displays in FIGS. 11A-11D may be presented to a user in response to the user selecting one or more tabs on the top bar of the display shown in FIG. 5A. For example, in response to the user selecting the tab “people” in FIG. 5A, display 3000 containing a table of people associated with one or more companies may be presented to the user. Thus, instead of displaying company activity on a geographic map using markers as in FIGS. 5A-5H, the company activity may be compiled into a list and/or table in the FIGS. 11A-11D. As shown in FIG. 11A, customized alerts may be presented to a user on a display 2800, in the form of a table. As such, the user can sort customized alerts by their name, city, date ranges, etc. Further, a user can filter the results shown in the table of display 2800. The table shown in display 2900 of FIG. 11B identifies a list of entities. The entities may be companies, and as such the companies may be sorted by a user based on their country of origin, type, ownership, etc.

Moving to FIG. 11C, it shows a display 3000 that lists people affiliated with one or more companies in a table. A user may sort the people by their name, job title, etc. FIG. 11D shows a display 3100 that may be presented to a user with transactions listed in the format of a table. The transactions may be sorted by title, status, date ranges, type, industries, companies involved, customers, location, etc.

While the above description relates to systems and methods for tracking company activity, specifically transactions they are involved, it should be appreciated that in other embodiments the above systems and methods may be applied in a similar manner as described above with other forms of activity with or without the examples of transactions. Said another way, the example control and estimation routines described herein can be used with various forms of activity. Other forms of activity may include, alone or in combination with one more of the other company activities: employment activity such as hiring and firing rates, government activity, military activity, terrorist activity, media coverage/exposure activity, etc.

In this way, systems and methods for tracking, and monitoring company activity, by way of a user interface are provided. Thus, a user may be able to visualize company activity patterns so that the underlying motivations behind such activity may be elucidated. Specifically, company activity may be presented to a user on a geographic map. A user may further filter the company activity presented on the map, so that only certain, types of transactions, companies and/or persons involved with those transactions, and events that are of interest to the user are shown on the map. By organizing company activity according to location, the activity patterns of a company or group of companies may be more transparent to a user, than by organizing the company activity in a list, table, or other form. Thus, a technical effect of increasing the transparency of company activity is achieved by presenting activities involving one or more companies on a map.

Further, a technical effect of increasing safety is achieved by generating personalized alerts that are tailored to a user's preferences. In particular, companies and their activity (e.g., transactions involving the companies) may be monitored according user defined parameters and/or preferences. For example, a user may select certain types of transaction or activity, transactions over a threshold dollar value, transactions occurring in a specified geographical region, etc., as having a higher risk factor. Thus, the risk factor of a company, their activity, and/or transactions may be adjusted based on user input. Further, company activity may be tracked based on the risk factor associated with each company, and a user may be notified of transactions and/or activity that poses more than a threshold amount of risk.

In this way, systems and methods are also included for identifying companies that may be collaborating with one another. Companies may be identified as collaborating with one another based on legally binding contracts that exist between the companies. In some examples, the systems and method may additionally include identifying companies that are collaborating with one another by identifying shared characteristics between companies, such as shareholders, interests, countries of origin, transactions, etc. Thus, companies that are collaborating with one another without public recognition may be identified. Further, the relationships between collaborating companies may be identified, so that it may become clearer how the interests of a company may be influenced by the companies they are associated with. As such, a technical effect of increasing the accuracy of predictions of company activity is achieved by identifying the relationships between associated companies. Since a company may control one or more other companies, a more complete understanding of the sphere of influence of a company may be obtained. In this way, by associating a first company one or more second companies, any actions taken by any of second companies may automatically be tied to the first company. Said another way, for a given transaction, not only may the companies directly involved in the transaction be identified as being involved with the transaction, but so too may all companies associated or collaborating with the directly involved companies.

Since companies often organize themselves into networks, their actions do not always reflect their own personal interests, but many times reflect the interests of the collective networks, which may be in line with, or unaligned with their own personal interests. Therefore, by discovering and recognizing the associations between companies, and identifying these complex networks, the behavior of these networks, and therefore the companies themselves may be better understood. With an improved understanding of company behavior, a user may be better able to anticipate future company activity, and can therefore plan their own actions more effectively to minimize risk and/or harm to themselves and their institutions. As such, the advancement of a user's own interests may be increased.

In one representation, a method may comprise receiving activity information regarding an activity involving one or more companies from one or more first storage devices, wherein the activity information includes one or more of a name, type, industry, date, monetary value, and location of the activity, and companies involved with the activity, identifying the companies involved with the activity based on the activity information, receiving company information regarding the companies involved with the activity from one or more second storage devices, the company information including an activity record of the companies involved with the activity, estimating a first risk level for the activity based on the company information, estimating a second risk level for the activity based on the activity information, determining a risk factor for the transaction based on the first risk level for each of the companies involved with the activity and the second risk level for the activity, generating an alert when the risk factor is greater than a threshold, and displaying the alert to a user on a display screen. In the above method, the company information may include one or more of: hiring records, yearly gross profits, yearly gross revenues, number of personnel, transaction records, ownership, ownership type, board members, country of domicile, sponsorships, contracts, promotions, conferences, press releases, and company involvement in high risk countries, high risk activity or, specifically, one or more of: government imposed sanctions, money laundering, worker abuse, and terrorist involvement. In any one or more combinations of the above methods, the method may further comprise identifying collaborating companies of the companies involved with the activity, and wherein the estimating the first risk level is further based on company information for the identified collaborating companies. In any one or more combinations of the above methods, the identifying the collaborating companies may comprise comparing characteristics of companies with the companies involved with the activity, where the characteristics may include one or more of: shareholders, executives, office locations, industry, transactions and transaction locations. Any one or more combinations of the above methods may further comprise analyzing the company information and predicting future company activity based on the analyzed company information, and wherein the alert may be generated when the activity included in the activity information is different by more than a threshold from the predicted company activity. Any one or more combinations of the above methods may further comprise receiving user preferences from a user device, wherein the user preferences include a risk level for one or more of: companies, types of transactions, monetary value ranges of transactions, persons, and locations. In any one or more combinations of the above methods, the estimating the second risk level may be further based on the user preferences, where the second risk level may increase for increasing matches between the user preferences and the activity information.

In another representation, a method may comprise receiving a user search input for one or more companies, receiving transaction information data associated with a list of one or more transactions involving the one or more companies, wherein the transaction information data includes one or more of monetary values, industries, dates, risk exposure, summary transaction description, and companies involved with the one or more transactions, receiving location data describing the locations of the one or more transactions, receiving company information data for each identified transaction in the list of the one or more transactions, wherein the received company information data includes one or more of a transaction history, management, total revenues, ownership type, and country of domicile of each of the one or more companies, identifying affiliate companies associated with the one or more companies involved in each identified transaction, analyzing, with a server computer, the location data and transaction information data and generating location-based transaction information, populating a geographic map with markers, where the markers correspond to the location of each identified transaction in the list of one or more transactions, and where the markers are generated based on the location-based transaction information, where the transactions may be differentiated based on user defined parameters, where each parameter is matched to a different visual marker, transmitting the populated geographic map to the user device, and displaying the populated geographic map on the user device. The above method may further comprise, responsive to a user selection of one of the markers, displaying to the user, the received information for the identified transaction corresponding to the user selected marker and the identified collaborating companies associated with the one or more companies involved in the identified transaction. In any one or more combinations of the above methods, the network may comprise two or more companies that are collaborating with one another by one or more of fund sharing, joint ownership, establishing a banking relationship, etc. In any one or more combinations of the above methods identifying the collaborating companies may comprise determining if the collaborating companies share more than a threshold number of characteristics with the one or more companies identified in each transaction, where the characteristics include one or more of: shareholders, executives, office locations, industry, type of transaction, etc. In any one or more combinations of the above methods identifying the collaborating companies may comprise determining if the collaborating companies are legally represented as partners or subsidiaries of the one or more companies identified in each transaction. Any one or more combinations of the above methods may further comprise storing one or more of the list of transactions, information about each identified transaction in the list of the one or more transactions, and the collaborating companies in non-transitory memory. In any one or more combinations of the above methods the one or more companies and the collaborating companies may include one or more of: companies, businesses, corporations, and state owned enterprises.

In another representation, a system for displaying transactions and office locations involving one or more companies may comprise: a first remote server, a remote device in wireless communication with the first remote server, one or more second remote servers, each of the one or more second remote servers comprising one or more storage devices, the first server comprising a storage device and a logic system the logic system storing computer readable instructions executable by said first remote server whereby said server is operative to: receive a list of one or more transactions identified from the one or more storage devices, receive transaction information about each transaction in the list of one or more transactions, wherein the received transaction information includes one or more of companies and persons involved in the transaction, a date, location, and amount of said transaction, industry in which the transaction took place, type of transaction, store the list of one or more transactions and transaction information in non-transitory memory of the storage device of the first server, and populate a geographic map with the list of one or more transactions based on the received transaction information. In any one or more combinations of the above systems, the receiving of the transaction information may occur periodically as part of a scheduled update. In any one or more combinations of the above systems the receiving of the transaction information may occur in response to a request from a user via the remote device. In any one or more combinations of the above systems the first remote server may be further operative to display the geographic map to the user via the user device with only a subset of the transactions in response to a user query. In any one or more combinations of the above systems, the subset of transactions included on the geographic map is adjustable by the user based on the transaction information. In any one or more combinations of the above systems, the one or more second remote servers include company information data, the company information data comprising one or more of: activity records, transaction records, hiring records, gross yearly profits, mergers, acquisitions, ownership, board members, sponsorships, contracts, promotions, conferences, press releases, and company involvement in one or more of: government imposed sanctions, money laundering, worker abuse, and terrorist involvement.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

Note that the example control and estimation routines included herein can be used with computing configurations. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the server, where the described actions are carried out by executing the instructions in a system including the user device.

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method comprising:
receiving activity information regarding an activity involving one or more companies from one or more first storage devices, wherein the activity information includes one or more of a name, type, industry, date, monetary value, and location of the activity, and companies involved with the activity;
identifying the companies involved with the activity based on the activity information;
receiving company information regarding the companies involved with the activity from one or more second storage devices, the company information including an activity record of the companies involved with the activity;
estimating a first risk level for the activity based on the company information;
estimating a second risk level for the activity based on the activity information;
determining a risk factor for the transaction based on the first risk level for each of the companies involved with the activity and the second risk level for the activity;
generating an alert when the risk factor is greater than a threshold; and
displaying the alert to a user on a display screen.

2. The method of claim 1, wherein the company information includes one or more of: hiring records, yearly gross profits, yearly gross revenue, number of personnel, transaction records, ownership, ownership type, board members, sponsorships, contracts, promotions, conferences, press releases, and company involvement in high risk countries, high risk activity or, specifically, one or more of: government imposed sanctions, money laundering, worker abuse, and terrorist involvement.

3. The method of claim 1, wherein the method further comprises identifying collaborating companies of the companies involved with the activity, and wherein the estimating the first risk level is further based on company information for the identified collaborating companies.

4. The method of claim 3, where the identifying the collaborating companies comprises comparing characteristics of companies with the companies involved with the activity, where the characteristics may include one or more of: shareholders, executives, office locations, industry, and transactions.

5. The method of claim 1 further comprising, analyzing the company information and predicting future company activity based on the analyzed company information, and wherein the alert is generated when the activity included in the activity information is different by more than a threshold from the predicted company activity.

6. The method of claim 1, further comprising receiving user preferences from a user device, wherein the user preferences include a risk level for one or more of: companies, types of transactions, monetary value ranges of transactions, persons, and locations.

7. The method of claim 6, wherein the estimating the second risk level is further based on the user preferences, where the second risk level may increase for increasing matches between the user preferences and the activity information.

8. A method, comprising:
receiving a user search input for one or more companies;
receiving transaction information data associated with a list of one or more transactions involving the one or more companies, wherein the transaction information data includes one or more of monetary values, industries, dates, risk exposure, summary transaction description, and companies involved with the one or more transactions;
receiving location data describing the locations of the one or more transactions;
receiving company information data for each identified transaction in the list of the one or more transactions, wherein the received company information data includes one or more of a transaction history, management, total revenues, ownership type, and country of domicile of each of the one or more companies;
identifying affiliate companies associated with the one or more companies involved in each identified transaction;
analyzing, with a server computer, the location data and transaction information data and generating location-based transaction information;
populating a geographic map with markers, where the markers correspond to the location of each identified transaction in the list of one or more transactions, and where the markers are generated based on the location-based transaction information, where the transactions may be differentiated based on user defined parameters, where each parameter is matched to a different visual marker;
transmitting the populated geographic map to the user device; and
displaying the populated geographic map on the user device.

9. The method of claim 8, further comprising, responsive to a user selection of one of the markers, displaying to the user, the received information for the identified transaction corresponding to the user selected marker and the identified collaborating companies associated with the one or more companies involved in the identified transaction.

10. The method of claim 8, wherein the network comprises two or more companies that are collaborating with one another by one or more of fund sharing, joint ownership, establishing a banking relationship, etc.

11. The method of claim 8, wherein identifying the collaborating companies comprises determining if the collaborating companies share more than a threshold number of characteristics with the one or more companies identified in each transaction, where the characteristics include one or more of: shareholders, executives, office locations, industry, transactions.

12. The method of claim 8, where identifying the collaborating companies comprises determining if the collaborating companies are legally represented as partners or subsidiaries of the one or more companies identified in each transaction.

13. The method of claim 8, further comprising storing one or more of the list of transactions, information about each identified transaction in the list of the one or more transactions, and the collaborating companies in non-transitory memory.

14. The method of claim 8, wherein the one or more companies and the collaborating companies include one or more of: companies, businesses, corporations, and state owned enterprises.

15. A system for displaying transactions and office locations involving one or more companies, the system comprising:
a first remote server;
a remote device in wireless communication with the first remote server;
one or more second remote servers, each of the one or more second remote servers comprising one or more storage devices;
the first server comprising a storage device and a logic system the logic system storing computer readable instructions executable by said first remote server whereby said server is operative to:
receive a list of one or more transactions identified from the one or more storage devices;
receive transaction information about each transaction in the list of one or more transactions, wherein the received transaction information includes one or more of companies and persons involved in the transaction, a date, location, and amount of said transaction, industry in which the transaction took place, type of transaction;
store the list of one or more transactions and transaction information in non-transitory memory of the storage device of the first server; and
populate a geographic map with the list of one or more transactions based on the received transaction information.

16. The system of claim 15, wherein the receiving of the transaction information occurs periodically as part of a scheduled update.

17. The system of claim 15, wherein the receiving of the transaction information occurs in response to a request from a user via the remote device.

18. The system of claim 15, where the first remote server is further operative to display the geographic map to the user via the user device with only a subset of the transactions in response to a user query.

19. The system of claim 18, wherein the subset of transactions included on the geographic map is adjustable by the user based on the transaction information.

20. The system of claim 15, wherein the one or more second remote servers include company information data, the company information data comprising one or more of: activity records, transaction records, hiring records, gross yearly profits, mergers, acquisitions, ownership, board members, sponsorships, contracts, promotions, conferences, press releases, and company involvement in one or more of: government imposed sanctions, money laundering, worker abuse, and terrorist involvement.
